(19) United States
(12) Patent Application Publication
(10) Pub. No.: US 2013/0016246 A1
(43) Pub. Date: Jan. 17, 2013

(54) IMAGE PROCESSING DEVICE AND ELECTRONIC APPARATUS

(71) Applicants: Haruo HATANAKA, Osaka (JP); Yoshiyuki TSUDA, Kyoto-shi (JP)

(72) Inventors: Haruo HATANAKA, Osaka (JP); Yoshiyuki TSUDA, Kyoto-shi (JP)

(73) Assignee: SANYO ELECTRIC CO., LTD., Osaka (JP)

(21) Appl. No.: 13/553,407

(22) Filed: Jul. 19, 2012

Related U.S. Application Data
(63) Continuation of application No. PCT/JP2011/050648, filed on Jan. 17, 2011.

(30) Foreign Application Priority Data
Jan. 20, 2010 (JP) 2010-009896
Dec. 27, 2010 (JP) 2010-289389
Jan. 7, 2011 (JP) 2011-002433

(51) Int. Cl. H04N 5/228

(52) U.S. Cl. 348/222.1; 348/E05.031

(57) ABSTRACT

An image processing device includes a correcting portion which corrects an image in a target region included in a first input image. The correcting portion includes a correction processing portion which corrects the image in the target region using an image in a region for correction included in a second input image that is the same as or different from the first input image, and a correction region extracting portion which extracts the region for correction from the second input image based on image data of the target region.

### BACKGROUND OF THE INVENTION

1. Field of the Invention

The present invention relates to an image processing device which performs image processing and an electronic apparatus having an image processing function.

2. Description of Related Art

There is a case where an unintentional flaw (a pattern like a flaw) or an unintentionally depicted unneeded matter is included in an arbitrary digital image obtained by photography using a digital camera. Using image editing software to edit (correct) the digital image, the unneeded object (the unneeded matter or pattern) can be eliminated from the digital image.

Numeral 910 in FIG. 18A indicates a digital image to be corrected. In the input image 910, there are two persons 911 and 912. It is supposed that the person 911 is a person of interest for a user, and the person 912 is an unneeded object for the user. The image editing software accepts an editing operation by the user in a state where the input image 910 is displayed on a display screen of a liquid crystal display or the like. The user regards an image region of the person 911 on the input image 910 as an unneeded region and performs the editing operation of filling in the unneeded region with an appropriate fill-in color. Thus, the user can obtain a desired image in which the unneeded object is eliminated. FIG. 18B illustrates a manner of the displayed image during the editing operation, in which numeral 913 indicates an icon for fill-in (icon like a brush).

In a conventional method using image editing software, it is necessary to perform all the above-mentioned editing work manually, which takes much time and effort. In particular, it is very difficult to perform the above-mentioned fine editing work using a small monitor and a cross cursor in a mobile electronic apparatus such as a digital camera.

Note that there is proposed a method of eliminating spots and wrinkles on a face in the image, but this method cannot support eliminating an unneeded object other than spots and wrinkles.

In addition, there is developed the following image processing software. It is supposed that an input image 920 including images of persons 921 to 923 as illustrated in FIG. 33 is supplied to the image processing software, and that the user regards the person 923 as an unneeded object. Then, the user specifies the unneeded region (region in which the unneeded object exists) AA in the input image 920 using a user interface. Then, the image processing software automatically selects a small region BB as illustrated in FIG. 34A and generates a result image 930 using a signal in the small region BB (see FIG. 34B). In the result image 930, the unneeded object that existed in the unneeded region AA is eliminated.

However, a result image that is different from a user's intention may be generated depending on a way of selecting the small region BB by the image processing software. For instance, if a small region BB′ including the person 922 as illustrated in FIG. 35A is selected as the small region BB, there is obtained a result image 930′ (see FIG. 35B) in which image data of the person 922 is reflected on small region AA, namely the result image 930′ in which the same person 922 is duplicated. An output of such a result image different from the user's intention should be avoided as much as possible.

### SUMMARY OF THE INVENTION

An image processing device according to the present invention includes a correcting portion which corrects an image in a target region included in a first input image. The correcting portion includes a correction processing portion which corrects the image in the target region using an image in a region for correction included in a second input image that is the same as or different from the first input image, and a correction region extracting portion which extracts the region for correction from the second input image based on image data of the target region.

An electronic apparatus according to the present invention includes the above-mentioned image processing device.

An electronic apparatus according to another aspect of the present invention includes an image processing device including a correcting portion which corrects an image in a target region included in the first input image, a display portion which displays a whole or a part of the first input image, and an operation portion which accepts an unneeded region specifying operation for specifying an unneeded region included in the first input image and accepts a correction instruction operation for instructing to correct an image in the unneeded region. The correcting portion includes a target region setting portion which sets an image region including the unneeded region as the target region, a correction processing portion which corrects the image in the target region using an image in a region for correction included in a second input image that is the same as or different from the first input image, and a correction region extracting portion which extracts the region for correction from the second input image based on image data of the target region. The correcting portion corrects the image in the target region in accordance with the correction instruction operation. When the correction is performed, the display portion displays the image in the target region after the correction.

Meanings and effects of the present invention will be apparent from the following description of the embodiment. However, the embodiment described below is merely an embodiment of the present invention, and meaning of terms of the present invention and each element are not limited to those described in the following embodiment.

### BRIEF DESCRIPTION OF THE DRAWINGS

FIG. 1 is a block diagram illustrating a general structure of an image pickup apparatus according to an embodiment of the present invention.

FIG. 2 is a diagram illustrating an image correcting portion which generates an output image from an input image according to the embodiment of the present invention.

FIG. 3 is a diagram illustrating a relationship between a two-dimensional image and a two-dimensional coordinate system XY.

FIG. 4 is a diagram illustrating an example of an input image to the image correcting portion illustrated in FIG. 2.

FIG. 5A is a diagram illustrating an image in a correction target region as a part of the input image illustrated in FIG. 4, and FIG. 5B is a diagram illustrating a masked image generated from the image illustrated in FIG. 5A.

FIG. 6A is a diagram illustrating a region similar to the above-mentioned masked image, and FIG. 6B is a diagram illustrating a correction patch region including the similar region.

FIG. 7 is a diagram illustrating an example of an output image based on the input image of FIG. 4.

FIG. 8A is a diagram illustrating a plurality of correction patch region candidates on the input image, which are set when a plurality of regions similar to the masked image are detected, and FIG. 8B is a diagram illustrating a manner in which the plurality of correction patch region candidates are emphasized on a displayed image.

FIG. 9 is a diagram illustrating a variation in a correction result of an correction target image when a coefficient (k_{MIX}) of mixing the image data is changed.

FIG. 10 is a diagram illustrating a manner of a display screen when the image in the correction target region is enlarged and displayed.

FIG. 11 is a diagram illustrating a manner in which a touch panel adjusting operation is performed by the user when the image in the correction target region is enlarged and displayed.

FIG. 12 is an action flowchart in an unneeded object elimination mode of the image pickup apparatus of FIG. 1.

FIG. 13 is a diagram illustrating a relationship between the unneeded region and the correction target region.

FIG. 14 is a diagram for explaining a distance between a pixel position of interest in the correction target region and an outer rim of the correction target region.

FIG. 15 is a diagram illustrating a relationship example between the above-mentioned distance and the coefficient of mixing the image data.

FIG. 16 is a detailed flowchart of the adjusting process illustrated in FIG. 12.

FIG. 17 is an internal block diagram of the image correcting portion illustrated in FIG. 1.

FIGS. 18A and 18B are diagrams for explaining a method of eliminating an unneeded object according to a conventional image editing software.

FIG. 19 is a diagram for explaining a specifying operation of specifying an unneeded region according to a second embodiment of the present invention.

FIG. 20 is a diagram illustrating a specified position in the input image according to a third embodiment of the present invention.

FIG. 21 is a diagram for explaining a head back detection process according to the third embodiment of the present invention.

FIG. 22 is a diagram for explaining a line detection process according to the third embodiment of the present invention.

FIGS. 23A and 23B are diagrams for explaining a moving object detection process according to the third embodiment of the present invention.

FIG. 24 is a diagram for explaining a signboard detection process according to the third embodiment of the present invention.

FIG. 25 is a diagram for explaining a spot detection method according to the third embodiment of the present invention.

FIG. 26 is an action flowchart of setting an unneeded region according to the third embodiment of the present invention.

FIG. 27 is an action flowchart of the image pickup apparatus in the unneeded object elimination mode according to a fourth embodiment of the present invention.

FIGS. 28A and 28B are diagram illustrating a manner in which a plurality of correction result images are sequentially displayed according to the fourth embodiment of the present invention.

FIG. 29 is a diagram illustrating a manner in which a plurality of correction result images are displayed simultaneously according to the fourth embodiment of the present invention.

FIG. 30 is a diagram illustrating a display content example of the display screen according to the fourth embodiment of the present invention.

FIG. 31 is a diagram illustrating a display content example of the display screen according to the fourth embodiment of the present invention.

FIGS. 32A to 32D are diagrams for explaining correction retry according to the fourth embodiment of the present invention.

FIG. 33 is a diagram illustrating an input image to another conventional image editing software.

FIGS. 34A and 34B are diagrams for explaining a method of eliminating an unneeded object by another conventional image editing software.

FIGS. 35A and 35B are diagrams for explaining the method of eliminating an unneeded object by another conventional image editing software.

FIGS. 36A to 36E are diagrams for explaining a method of eliminating an unneeded object according to a fifth embodiment of the present invention.

FIG. 37 is a diagram illustrating an extraction inhibit region setting portion according to the fifth embodiment of the present invention.

FIG. 38 is an internal block diagram of the image correcting portion according to the fifth embodiment of the present invention.

FIG. 39 is an action flowchart of the image pickup apparatus according to the fifth embodiment of the present invention.

### DETAILED DESCRIPTION OF THE PREFERRED EMBODIMENTS

Hereinafter, embodiments of the present invention will be described in detail with reference to the attached drawings. In the drawings to be referred to, the same portions are denoted by the same numerals or symbols, and overlapping description of the same portions are omitted as a rule.

### First Embodiment

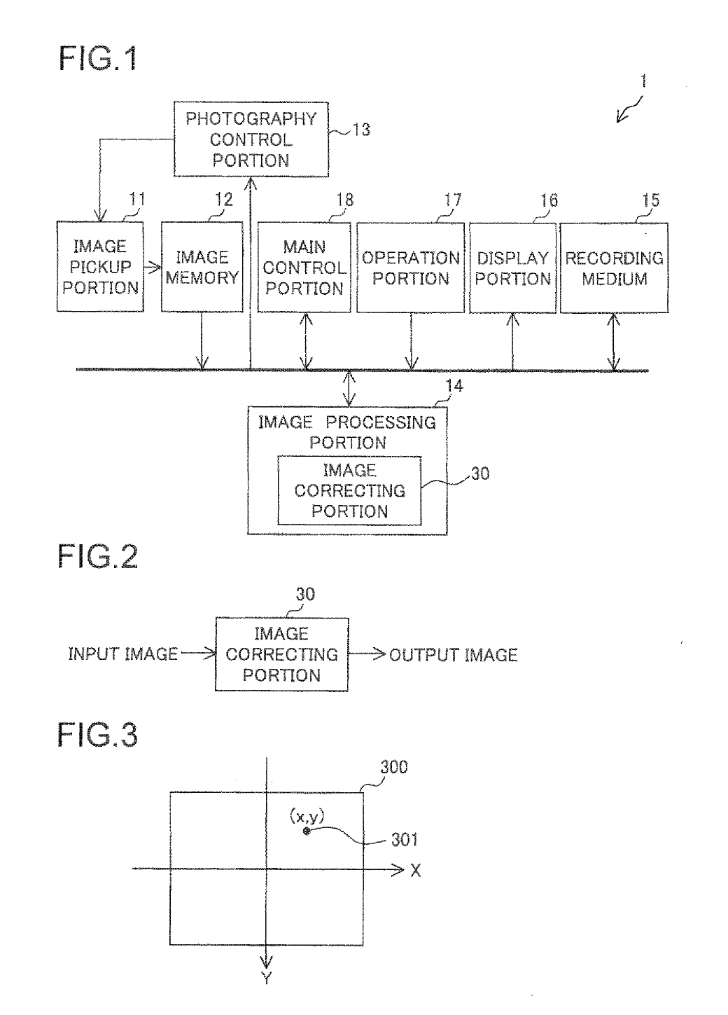

A first embodiment of the present invention is described. FIG. 1 is a block diagram illustrating a general structure of an image pickup apparatus 1 according to the first embodiment of the present invention. The image pickup apparatus 1 includes individual portions denoted by numerals 11 to 18. The image pickup apparatus 1 is a digital video camera which can take still images and moving images. However, the image pickup apparatus 1 may be a digital still camera which can take only still images. Note that the display portion 16 may be interpreted to be disposed in a display device or the like different from the image pickup apparatus 1.

The image pickup portion 11 takes an image of a subject using an image sensor so as to obtain image data of the image of the subject. Specifically, the image pickup portion 11 includes an optical system, an aperture stop, and an image sensor constituted of a charge coupled device (CCD) or a complementary metal oxide semiconductor (CMOS) image sensor and the like, which are not shown in the diagram. The image sensor performs photoelectric conversion of an optical image of the subject, which enters via the optical system and the aperture stop, so as to output an analog electric signal obtained by the photoelectric conversion. An analog front end (AFE) (not shown) amplifies the analog signal output from the image sensor and converts the amplified analog signal into a digital signal. The obtained digital signal is recorded as image data of the image of the subject in the image memory 12 constituted of a synchronous dynamic random access memory (SDRAM) or the like.

An image expressed by image data of one frame period recorded in the image memory 12 is called a frame image. Note that in this specification the image data may be referred to simply as an image. In addition, image data of a certain pixel may be referred to as a pixel signal. The pixel signal is constituted of a luminance signal indicating luminance of the pixel and a color difference signal indicating a color of the pixel, for example.

The photography control portion 13 adjusts an angle of view (focal length), a focal position, and incident light intensity to the image sensor of the image pickup portion 11 based on a user's instruction and image data of the frame image.

The image processing portion 14 performs a predetermined image processing (demosaicing process, noise reduction process, edge enhancement process, and the like) on the frame image.

The recording medium 15 is constituted of a nonvolatile semiconductor memory, a magnetic disk, or the like, and records image data of the frame image after the above-mentioned image processing, image data of the frame image before the above-mentioned image processing, and the like. The display portion 16 is a display device constituted of a liquid crystal display panel or the like, and displays the frame image and the like. The operation portion (operation accepting portion) 17 accepts an operation by a user. The operation content with respect the operation portion 17 is sent to the main control portion 18. The main control portion 18 integrally controls actions of individual portions in the image pickup apparatus 1 in accordance with the operation content performed with respect to the operation portion 17.

The display portion 16 is equipped with a so-called touch panel function, and the user can perform touch panel operation by touching the display screen of the display portion 16 with a touching member. The touching member is a finger or a prepared touching pen. The operation portion 17 also takes part in realizing the touch panel function. In this embodiment, the touch panel operation is considered to be one type of operation with respect to the operation portion 17 (the same is true for other embodiments described later). The operation portion 17 sequentially detects positions on the display screen contacted by the touching member, so as to recognize contents of touch panel operations by the user. Note that the display and the display screen in the following description mean a display and a display screen on the display portion 16 unless otherwise noted, and the operation in the following description means an operation with respect to the operation portion 17 unless otherwise noted.

The image processing portion 14 includes an image correcting portion (correcting portion) 30. As illustrated in FIG. 2, the image correcting portion 30 has a function of correcting the input image and generates a corrected input image as an output image. The input image may be an image recorded in the recording medium 15 (an image obtained by photography with the image pickup portion 11) or may be an image supplied from the other apparatus than the image pickup apparatus 1 (for example, an image recorded in a distant file server). The image described in this specification is a two-dimensional image unless otherwise noted.

In addition, as illustrated in FIG. 3, there is defined a two-dimensional coordinate system XY on a spatial domain in which an arbitrary two-dimensional image 300 is disposed. The two-dimensional image 300 is the above-mentioned input image or output image, for example. An X axis and a Y axis are axes along the horizontal direction and the vertical direction of the two-dimensional image 300. The two-dimensional image 300 is constituted of a plurality of pixels arranged like a matrix in the horizontal direction and in the vertical direction, and a position of the pixel 301 as an arbitrary pixel on the two-dimensional image 300 is expressed by (x, y). In this specification, a position of a pixel is also referred to simply as a pixel position. Symbols x and y are coordinate values of the pixel 301 in the X axis direction and in the Y axis direction, respectively. In addition, in this specification, the pixel disposed at the pixel position (x, y) may also be referred to as (x, y). In the two-dimensional coordinate system XY, if a position of a certain pixel is shifted to the right side by one pixel, the coordinate value of the pixel in the X axis direction is increased by one. If a position of a certain pixel is shifted to the lower side by one pixel, the coordinate value of the pixel in the Y axis direction is increased by one. Therefore, if a position of the pixel 301 is (x, y), positions of pixels adjacent the pixel 301 in right, left, lower, and upper directions are expressed by (x+1, y), (x−1, y), (x, y+1), and (x, y−1), respectively.

[Correction Method of Input Image]

Directly describing, the image correcting portion 30 automatically detects an image region which is similar to the image region of the unneeded object existing in the input image and does not include the unneeded object and uses the detected region as a correction patch region so as to correct the image region of the unneeded object (simply by replacing the image region of the unneeded object with the correction patch region), and hence the output image is generated. The correction process by the image correcting portion 30 is performed in a reproduction mode for reproducing and displaying images recorded in the recording medium 15 on the display portion 16. In the following description, the action in the reproduction mode of the image pickup apparatus 1 is described unless otherwise noted. A correction method of the input image is described in detail.

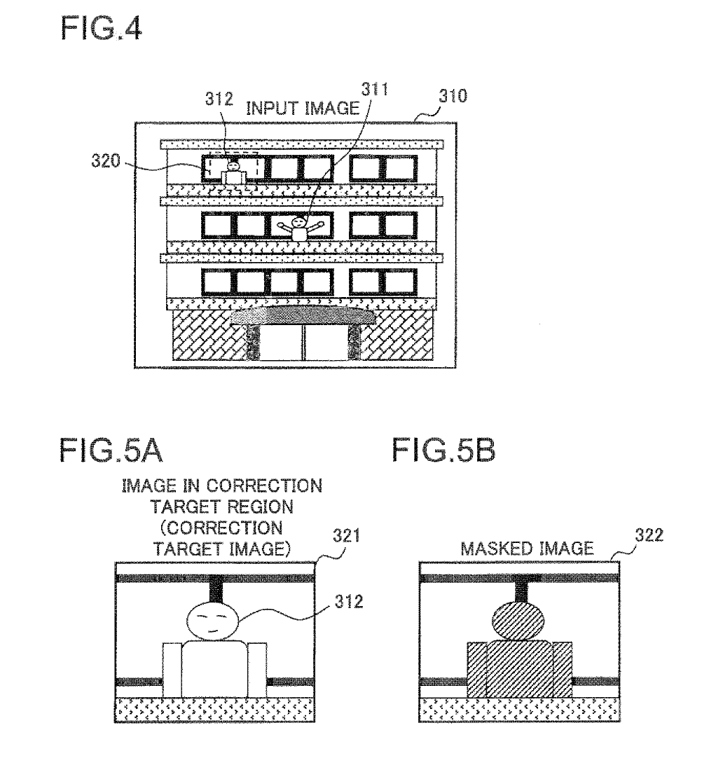

Numeral 310 in FIG. 4 indicates the input image to be corrected. The input image 310 is displayed on the display portion 16. It is supposed that an unneeded matter, pattern or the like for the user exists in the input image 310 and that the user wants to eliminate the unneeded matter, pattern or the like from the input image 310. The unneeded matter, pattern or the like is referred to as the unneeded object. The image region in which there is image data of the unneeded object is referred to as an unneeded region. The unneeded region is a part of the entire image region of the input image and is a closed region including the unneeded object.

As illustrated in FIG. 4, the input image 310 includes two persons 311 and 312. It is supposed that the person 311 is a person of interest for the user and that the person 312 is an unneeded object for the user. In this case, the user performs an unneeded region specifying operation for specifying the unneeded region with the operation portion 17. When the unneeded region specifying operation is performed, the entire input image 310 is displayed on the display screen. Alternatively, a part of the input image 310 is displayed on the display screen so that the unneeded object is enlarged and displayed. In order to facilitate specifying the unneeded region, the user can instruct the image pickup apparatus 1 to perform the enlarging display via the operation portion 17.

The unneeded region specifying operation can be realized by the touch panel operation. For instance, by specifying a position where the person 312 as the unneeded object is displayed using the touching member, the unneeded region can be specified. When the display position of the person 312 is specified, the image correcting portion 30 extracts a contour of the person 312 using a known contour tracing method based on image data of the input image 310 so as to set an image region surrounded by the contour of the person 312 as the unneeded region. However, the user may directly specify the contour of the unneeded region. Note that it is also possible to perform the unneeded region specifying operation by an operation other than the touch panel operation (for example, an operation with a cross key disposed in the operation portion 17).

When the unneeded region is specified, the image correcting portion 30 sets the image region including the unneeded region as the correction target region (i.e., the region to be corrected). The unneeded region is a part of the correction target region. The correction target region is automatically set without a user's operation. However, it is possible that the user specifies the position and size of the correction target region. The region surrounded by a broken line in FIG. 4 is a correction target region 320, and FIG. 5A illustrates a correction target image (an image to be corrected) 321, which is an image in the correction target region 320. It is supposed that the contour of the unneeded region is the contour of the person 312.

After the correction target region 320 is set, the image correcting portion 30 generates an image in which only the unneeded region in the correction target region 320 is masked as a masked image 322. FIG. 5B is an image diagram of the masked image 322. In FIG. 5B, the hatched region indicates the masked region. The correction target region 320 can be decomposed into an unneeded region and other image region (remaining region), and an image constituted of only image data of the latter image region (perforated two-dimensional image) is the masked image 322.

After the masked image 322 is set, the image correcting portion 30 searches for an image region having an image similar to the masked image 322 (hereinafter referred to as a region similar to the masked image 322) in the input image 310 using an image matching method based on comparison between image data of the masked image 322 and image data of the input image 310 (image data other than the correction target region 320) or the like. In other words, for example, the masked image 322 is used as a template, and an image region having an image feature similar to the image feature of the masked image 322 is searched for in the input image 310. Then, an image region including the found similar region is extracted as the correction patch region (region for correction) from the input image 310.

For instance, an evaluation region having the same size and shape as the image region of the masked image 322 is set on the input image 310, and a sum of squared difference (SSD) or a sum of absolute difference (SAD) between the pixel signal in the masked image 322 and the pixel signal in the evaluation region is determined. Then, similarity between the masked image 322 and the evaluation region (in other words, similarity between the masked image 322 and the image in the evaluation region) is determined based on the SSD or the SAD. The similarity is decreased as the SSD or the SAD increases, and the similarity is increased as the SSD or the SAD decreases. When a square of a difference between the pixel signal (for example, a luminance value) in the masked image 322 and the pixel signal (for example, a luminance value) in the evaluation region is determined between corresponding pixels of the masked image 322 and the evaluation region, a sum value of the square values determined for all pixels in the masked image 322 is the SSD. When an absolute value of a difference between the pixel signal (for example, a luminance value) in the masked image 322 and the pixel signal (for example, a luminance value) in the evaluation region is determined between corresponding pixels of the masked image 322 and the evaluation region, a sum value of the absolute values determined for all pixels in the masked image 322 is the SAD. The image correcting portion 30 moves the evaluation region in the horizontal or vertical direction one by one pixel on the input image 310, and determines the SSD or the SAD and the similarity every time of the movement. Then, the evaluation region in which the determined similarity becomes a predetermined reference similarity or higher is detected as the region similar to the masked image 322. In other words, if a certain image region of interest is the region similar to the masked image 322, it means that the similarity between the image in the image region of interest and the masked image 322 is the predetermined reference similarity or higher.

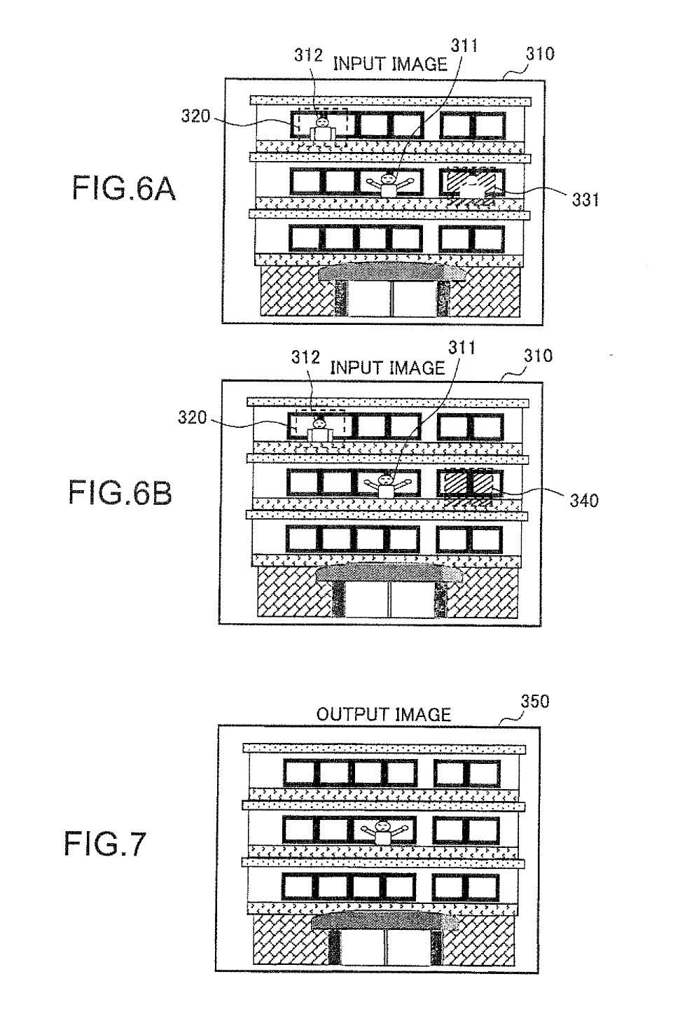

It is supposed that an image region 331 illustrated in FIG. 6A is searched for as the region similar to the masked image 322. In this case, the image correcting portion 30 sets a correction patch region 340 illustrated in FIG. 6B, which includes the image region 331. The image region 331 is the hatched region in FIG. 6A, and the correction patch region 340 is the hatched region in FIG. 6B. The shape and size of the image region 331 are the same as those of the masked image 322, and the shape and size of the correction patch region 340 are the same as those of the correction target region 320. The image region 331 is a rectangular region a part of which is lacked, but the correction patch region 340 has no lack. The correction patch region 340 is a region obtained by combining the lacked region and the image region 331.

After setting the correction patch region 340, the image correcting portion 30 mixes the image data in the correction target region 320 and the image data in the correction patch region 340 (in other words, performs weighted addition of them), so as to correct the image in the correction target region 320. The image data obtained by the mixing is handled as image data of the correction target region 320 in the output image. In other words, an output image based on the input image 310 is the image obtained by performing the above-mentioned mixing process on the input image 310.

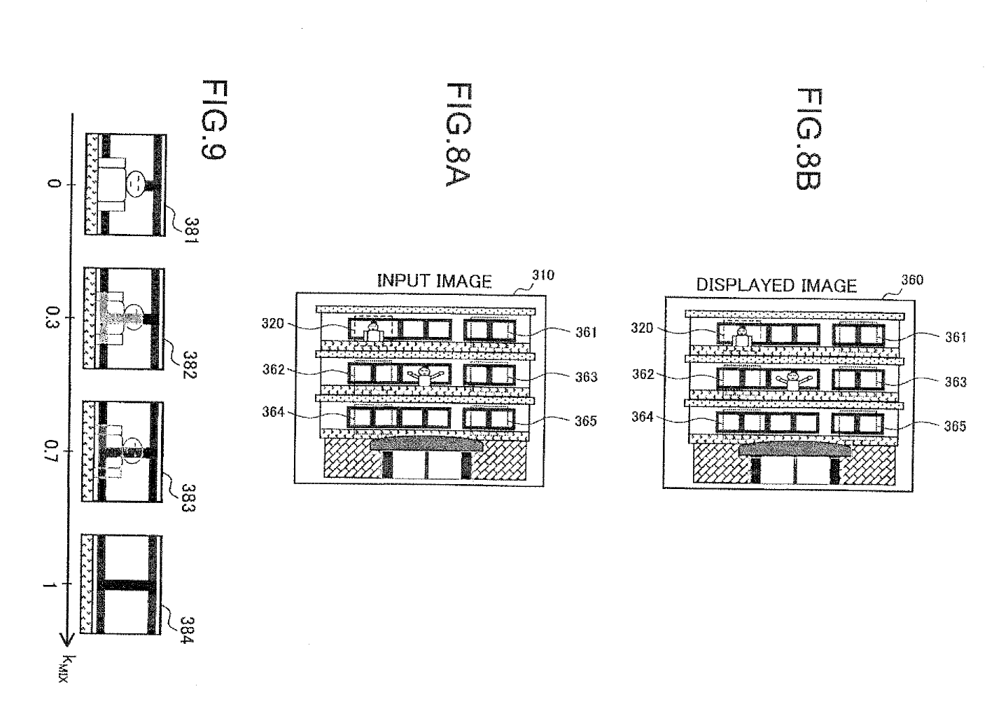

FIG. 7 illustrates an output image 350 as an example of the output image based on the input image 310. The input image 310 and the output image 350 are the same except for that image data in the correction target region 320 is different between the input image 310 and the output image 350. The output image 350 is obtained when the mixing ratio of image data in the correction patch region 340 is set to a substantially high value, and the person 312 is not seen at all or hardly seen in the output image 350. The mixing ratio of image data in the correction patch region 340 (a value of a coefficient k_{MIX} described later) may be one. If the mixing ratio is one, the image data in the correction target region 320 is replaced with the image data in the correction patch region 340. In this way, the output image 350 can be obtained by performing the process of correcting the image in the correction target region 320 using the image in the correction patch region 340 on the input image 310.

It is supposed that a certain pixel position in the correction target region 320 is (x₁, y₁) and that a pixel position of the pixel in the correction patch region 340 corresponding to the pixel disposed at the pixel position (x₁, y₁) is (x₂, y₂). Then, a pixel signal P_{OUT}(x₁, y₁) of the pixel position (x₁, y₁) in the output image 350 is calculated by the following equation (1).

P_{OUT}(x₁,y₁)=(1−k_{MIX})·P_{IN}(x₁,y₁)+k_{MIX}·P_{IN}(x₂,y₂) (1)

Here, P_{IN}(x₁, y₁) and P_{IN}(x₂, y₂) respectively indicate pixel signals at the pixel positions (x₁, y₁) and (x₂, y₂) in the input image 310. Supposing that on the input image 310, a position after the center position of the correction target region 320 is moved to the right side by Δx pixel and to the lower side by Δy pixel is the center position of the correction patch region 340, x₂=x₁+Δx and y₂=y₁+Δy are satisfied (Δx and Δy are integers). The pixel signals P_{IN}(x₁, y₁) and P_{IN}(x₂, y₂) are signals indicating luminance and color of pixels at the pixel positions (x₁, y₁) and (x₂, y₂) in the input image 310, respectively, and are expressed in an RGB format or a YUV format, for example. Similarly, the pixel signal P_{OUT}(x₁, y₁) is a signal indicating luminance and color of a pixel at the pixel position (x₁, y₁) in the output image 350, and is expressed in the RGB format or the YUV format, for example. If each pixel signal is constituted of R, G, and B signals, the pixel signals P_{N}(x₁, y₁) and P_{IN}(x₂, y₂) should be mixed individually for each of R, G, and B signals so that the pixel signal P_{OUT}(x₁, y₁) is obtained. The same is true for the case where the pixel signal P_{IN}(x₁, y₁) or the like is constituted of Y, U, and V signals.

The image correcting portion 30 determines a value of the coefficient k_{MIX} within the range satisfying “0<k_{MIX}≦1”. The coefficient k_{MIX} corresponds to a mixing ratio (weighted addition ratio) of the correction patch region 340 with respect to the output image 350, and the coefficient (1−k_{MIX}) corresponds to a mixing ratio (weighted addition ratio) of the correction target region 320 with respect to the output image 350.

If the image 321 in the correction target region 320 (see FIG. 5A) is used as a template so as to search for the correction patch region, the image region including the person 311 is set as the correction patch region with high probability. If the image region including the person 311 is set as the correction patch region, an image of the person 311 appears in the correction target region after the correction by the above-mentioned mixing (weighted addition) of image data. Such appearance of the image is not desired. In view of this, the image correcting portion 30 searches for and sets the correction patch region using the masked image 322 in which the unneeded region is masked. Therefore, it is possible to detect the correction patch region suitable for eliminating the unneeded object without affected by the unneeded object.

Note that if a plurality of regions similar to the masked image 322 are detected, the user should select the similar region to be included in the correction patch region among the detected plurality of similar regions. For instance, if five similar regions are detected as the regions similar to the masked image 322, correction patch region candidates corresponding to the individual similar regions are set using the same method as that for setting the correction patch region 340 from the image region 331 (see FIGS. 6A and 6B). Numerals 361 to 365 in FIG. 8A indicate five correction patch region candidates set here. After each correction patch region candidate is set, the image correcting portion 30 controls the display portion 16 to display a displayed image 360 as illustrated in FIG. 8B, in which the correction target region 320 and the correction patch region candidates 361 to 365 are clearly displayed. The displayed image 360 is an image in which a frame for visually identifying the correction target region 320 and the correction patch region candidates 361 to 365 are overlaid on the input image 310. In the state where the displayed image 360 is displayed, the operation portion 17 accepts a selection operation (including the touch panel operation) for selecting one of the correction patch region candidates 361 to 365, and the image correcting portion 30 sets the selected correction patch region candidate as the correction patch region when the selection operation is performed. With this structure enabling the selection operation, it is possible to set the correction patch region that is more suitable for eliminating the unneeded object without imposing a large burden on the user.

In addition, the region similar to the masked image 322 is searched for in the input image 310 in the above-mentioned example, but it is possible to search for the region similar to the masked image 322 in an input image 370 (not shown) different from the input image 310 and to extract the correction patch region from the input image 370. Thus, even if the region similar to the masked image 322 is not included in the input image 310, it is possible to eliminate the unneeded object appropriately. However, in the following descriptions, it is supposed that the correction target region and the correction patch region are set in a common input image unless otherwise noted. Similarly to the input image 310, the input image 370 may be an image recorded in the recording medium 15 (image obtained by photography with the image pickup portion 11), or may be an image supplied from an apparatus other than the image pickup apparatus 1 (for example, an image recorded in a distant file server).

In addition, only the image data in the correction target region 320 is used for forming the masked image 322 in the above description, but it is possible to perform searching for the region similar to the masked image 322 and to set the correction patch region based on a result of the searching after image data of surrounding pixels of the correction target region 320 is also included in the masked image 322. In other words, for example, it is possible to note an image region larger than the correction target region, which includes the correction target region 320, and to use an image formed by the region remaining after the unneeded region is eliminated from the noted image region as the masked image 322.

In addition, when correcting human skin or hair, it is possible to use position information of individual portions (face, eyes, nose, arms, and the like) of human body (information indicating position on the input image) for setting the correction patch region. For instance, it is supposed that faces of first and second persons are included in the input image and that wrinkles at the corners of first person's eyes are unneeded objects. First, the image correcting portion 30 may detect a face region including the first person's face and a face region including the second person's face from the input image by a face detection process based on image data of the input image, and may specify the image regions of a part in which the corners of eyes exist in each face region. Then, the image region of the part in which the corners of the first person's eyes exist may be set to the correction target region, while the image region of the part in which the corners of the second person's eyes exist may be set to the correction patch region. Then, the image data of the correction target region and the image data of the correction patch region may be mixed, or the correction target region may be simply replaced with the correction patch region, so as to correct the input image. If there is no wrinkles at corners of the second person's eyes, the wrinkles at corners of the first person's eyes become inconspicuous or there is no wrinkles at corners of the first person's eyes on the output image obtained by the above-mentioned correction. Using this method, even if the similar region is not detected by matching using the template, an unneeded object can be eliminated in a desired manner.

[Adjust Function of Correction Strength]

The image correcting portion 30 has a function of adjusting correction strength (correction amount) of the correction target region 320 by adjusting a value of the above-mentioned coefficient k_{MIX}. For instance, the image correcting portion 30 can determine a value of the coefficient k_{MIX} in accordance with similarity DS (degree of similarity) between the image feature of the masked image 322 and the image feature of the image region 331 included in the correction patch region 340 (see FIGS. 6A and 6B). If the contribution (k_{MIX}) of the correction patch region 340 to the output image is set to be too high in a case of low similarity DS, a boundary of the corrected part becomes conspicuous so that an unnatural output image may be obtained. In view of this, the image correcting portion 30 adjusts the value of the coefficient k_{MIX} in accordance with the similarity DS, so that the value of the coefficient k_{MIX} becomes larger as the similarity DS becomes larger, and that the value of the coefficient k_{MIX} becomes smaller as the similarity DS becomes smaller. Thus, the boundary of the corrected part becomes inconspicuous.

Note that it can be said that the correction by mixing the image data in the correction target region with the image data in the correction patch region is also a method of transplanting the image data in the correction patch region into the correction target region (the image data in the correction patch region is completely transplanted if k_{MIX} is one, but the same is incompletely transplanted if k_{MIX} is smaller than one). In addition, the correction by mixing the image data in the correction target region with the image data in the correction patch region is referred to as mixing correction in particular in the following description, and the image in the correction target region after the mixing correction is referred to as a resulting mixed image.

FIG. 9 illustrates a variation in the correction result of the correction target image when the coefficient k_{MIX} is changed. In FIG. 9, each of images 381 to 384 indicates the resulting mixed image based on the correction target region 320 and the correction patch region 340. The images 382, 383, and 384 indicate the resulting mixed images when the coefficient k_{MIX} is 0.3, 0.7, and 1.0, respectively, and the image 381 indicates the resulting mixed image when the coefficient k_{MIX} is almost zero. In this way, as the coefficient k_{MIX} is increased, the correction strength of the correction target region 320 is increased, and an elimination degree of the unneeded object is increased.

In addition, the user can adjust the coefficient k_{MIX} by performing a predetermined adjusting operation with the operation portion 17. Using the adjusting operation as described below, it is possible to attenuate the image of the unneeded object by a simple operation, while making the boundary of the corrected part inconspicuous. As the adjusting operation, it is possible to adopt a touch panel adjusting operation using the touch panel function.

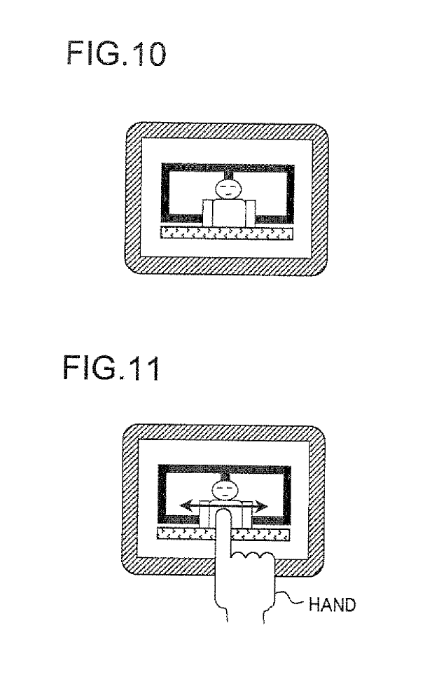

When the adjusting operation including the touch panel adjusting operation is performed, the image correcting portion 30 can make the image in the correction target region 320 before correction or after correction be enlarged and displayed on the display screen. It is possible that the user instructs the image pickup apparatus 1 to perform the enlarging display. FIG. 10 illustrates a manner of the display screen when the image in the correction target region 320 is enlarged and displayed. In FIG. 10 and in FIG. 11 as referred to later, the hatched region indicates a case of the display portion 16, and the region inside the hatched region indicates the display screen. When the coefficient k_{MIX} is changed by the adjusting operation, the mixing correction is performed promptly on the correction target region 320 using the changed coefficient k_{MIX}, and the resulting mixed image generated by using the changed coefficient k_{MIX} is displayed on the display screen.

When the touch panel adjusting operation is used, the coefficient k_{MIX} can be adjusted in accordance with at least one of the number of vibration of the touching member when the touching member is vibrated on the display screen of the display portion 16, a frequency of the vibration of the touching member in the above-mentioned vibration action, a moving speed of the touching member in the above-mentioned vibration action, a vibration amplitude of the touching member in the above-mentioned vibration action, a moving direction of the touching member on the display screen, the number of touching members that are touching the display screen (for example, the number of fingers), and a pressure exerted by the touching member on the display screen.

As a matter of course, it is supposed that the touching member touches the display screen of the display portion 16 when the touch panel adjusting operation is performed.

FIG. 11 illustrates an image diagram of the above-mentioned vibration action in a case where the touching member is a finger. The above-mentioned vibration action means an action of reciprocating a position of contact between the display screen and the touching member between the first and second positions on the display screen. Here, the first and second positions are different positions. The first and second positions should be interpreted to be positions having a certain range, and the first and second positions may be referred to as first and second display regions, respectively.

For instance, it is possible to increase or decrease the coefficient k_{MIX} as the number of vibration increases, from a start point as a state where the value of the coefficient k_{MIX} is a certain reference value. In this case, in accordance with an increase of the number of vibration by one, the coefficient k_{MIX} is increased or decreased by Δk (Δk>0). In addition, when the coefficient k_{MIX} is increased or decreased by the number of vibration, it is possible to increase Δk as a unit variation of the coefficient k_{MIX} along with an increase of the above-mentioned frequency, speed, or amplitude.

Typically, it is preferred to increase the coefficient k_{MIX} along with an increase of the number of vibration. In this case, it is confirmed on the display screen how the unneeded object becomes attenuated as the touching member is moved in a reciprocating manner on the display screen. In addition, with the structure in which Δk is increased along with an increase of the above-mentioned speed or the like, it is confirmed on the display screen how the unneeded object becomes attenuated faster as the touching member is moved faster in a reciprocating manner on the display screen. In other words, it is possible to realize an intuitive user interface as if using an eraser to erase unneeded description on a paper sheet.

Note that if k_{MIX} is zero, the image in the correction target region is not corrected at all. Therefore, the coefficient k_{MIX} is adjusted within the range satisfying 0<k_{MIX}≦1 in principle. However, in order to confirm the effect of correction, it is possible to set k_{MIX} to zero only when the adjusting operation is performed. When k_{MIX} is set to a value larger than zero by the adjusting operation, the image in the correction target region is corrected in accordance with a value of k_{MIX}. Therefore, the adjusting operation can be said to be an operation of instructing to correct the image in the correction target region (image in the unneeded region).

In addition, for example, it is possible to determine the direction of increasing or decreasing the coefficient k_{MIX} in accordance with the moving direction of the touching member on the display screen. In other words, for example, it is possible that if the above-mentioned moving direction is parallel to the horizontal direction on the display screen, the coefficient k_{MIX} is adjusted in the increasing direction, and that if the above-mentioned moving direction is parallel to the vertical direction on the display screen, the coefficient k_{MIX} is adjusted in the decreasing direction (as a matter of course, the opposite operation is possible). The determination of the increase or decrease direction of the coefficient k_{MIX} by the moving direction of the touching member and the adjustment of the coefficient k_{MIX} by the vibration action of the touching member can be combined. When this combination is performed, it should be determined whether to change the coefficient k_{MIX} in the increasing direction or to change the coefficient k_{MIX} in the decreasing direction in accordance with the moving direction of the touching member in the vibration action of the touching member.

In addition, for example, it is possible to determine the variation amount of the coefficient k_{MIX} or the increase or decrease direction of the coefficient k_{MIX} in accordance with the number of touching members that are touching the display screen. The determination of the variation amount of the coefficient k_{MIX} by the above-mentioned number and the adjustment of the coefficient k_{MIX} by the vibration action of the touching member can be combined. When this combination is performed, it is preferred to increase Δk along with an increase of the above-mentioned number, for example. In this case, the coefficient k_{MIX} is changed faster in a case where two touching members are used for the vibration action on the display screen than in a case where one touching member is used for the vibration action on the display screen. In addition, the determination of the increase or decrease direction of the coefficient k_{MIX} by the above-mentioned number and the adjustment of the coefficient k_{MIX} by the vibration action of the touching member can be combined. When this combination is performed, it should be determined whether to change the coefficient k_{MIX} in the increasing direction or to change the coefficient k_{MIX} in the decreasing direction in accordance with the number of touching members used for the vibration action on the display screen.

In addition, it is possible to increase the coefficient k_{MIX} along with an increase of a pressure exerted by the touching member on the display screen, for example (it is possible to decrease on the contrary). In addition, it is possible to combine the pressure and the vibration action so as to adjust the coefficient k_{MIX}. In this case, for example, it is possible to increase Δk along with an increase of the pressure while performing the adjustment of the coefficient k_{MIX} by the vibration action of the touching member.

Note that the determination of the increase or decrease direction of the coefficient k_{MIX} and the change of the coefficient k_{MIX} may be performed by an adjusting operation other than the touch panel adjusting operation. For instance, if the operation portion 17 is equipped with a slider type switch or a dial type switch, an operation of the switch may be used as the adjusting operation so as to determine the increase or decrease direction of the coefficient k_{MIX} and to change the coefficient k_{MIX}. If the operation portion 17 is equipped with a toggle switch, it is possible to determine the increase or decrease direction of the coefficient k_{MIX} and to change the coefficient k_{MIX} in accordance with an operation of the toggle switch. In addition, it is possible to display a menu for adjustment (for example, a menu for selecting strong, middle, or weak of the correction strength) on the display screen, and to perform the determination of the increase or decrease direction of the coefficient k_{MIX} and change of the coefficient k_{MIX} in accordance with a user's operation corresponding to the menu for adjustment.

In addition, when the correction strength is being adjusted by the touch panel adjusting operation, the resulting mixed image may be hidden behind the touching member to be hard to confirm depending on a display position of the resulting mixed image. Therefore, it is preferred to display the resulting mixed image at a display position other than an operating position when adjusting the correction strength by the touch panel adjusting operation (adjustment of the coefficient k_{MIX}). Thus, the correction strength can be easily adjusted. The operating position includes the contact position between the display screen and the touching member and may further include positions expected to be touched by the touching member on the display screen (for example, positions in the locus of the contact position between the display screen and the touching member in the above-mentioned vibration action). In addition, because it is assumed that there is user's hand in the lower part of the display screen, it is preferred to display the resulting mixed image in the upper part of the display screen.

In addition, the image correcting portion 30 may perform the following process. First to n-th different coefficient values to be substituted into the coefficient k_{MIX} are prepared, and the mixing correction is performed in the state where the i-th coefficient value is substituted into the coefficient k_{MIX} so as to generate the i-th resulting mixed image (n is an integer of two or larger, and i is an integer from one to n). This generating process is performed for each value of i of 1, 2, . . . , (n−1), n, so as to generate first to n-th resulting mixed images. The obtained first to n-th resulting mixed image (correction candidate images) are displayed on the display screen. In the state where this display is performed, the operation portion 17 accepts the selection operation of selecting one of the first to n-th resulting mixed images. The image correcting portion 30 generates the output image using the resulting mixed image selected in the selection operation. For instance, if n is three, the resulting mixed images 382 to 384 (see FIG. 9) as the first to third resulting mixed images are generated, and the resulting mixed images 382 to 384 are displayed on the display screen. Then, for example, if the image 383 is selected by the selection operation, the output image is generated using the image 383. In other words, the correction target region 320 of the input image 310 is corrected by the mixing correction using the coefficient k_{MIX} (=0.7) corresponding to the image 383, and the output image including the resulting mixed image 383 obtained by the correction is generated. Because this process can be performed, the user can obtain a desired correction result (output image) by a simple work.

[Correction by Dilation Process]

The method of eliminating the unneeded object by the image processing is roughly divided into a transplanting method and a dilating method. The transplanting method is a method of eliminating the unneeded object in the correction target region using the image in an image region other than the correction target region as described above. The dilating method is a method of shrinking or completely erasing the unneeded region using an dilation process to dilate the surrounding region of the unneeded region. The transplanting method has a problem that if the similar region is not found in the input image, the correction cannot be performed. On the other hand, the dilating method can eliminate the unneeded object without incompatibility if the unneeded object is a thin linear object (such as a character or an electric wire), but it has a demerit that if the unneeded object has a certain thickness, the correction result has a part filled with a single color in which the boundary of the corrected part is conspicuous. In view of these characteristics, it is possible to correct the correction target region by the dilating method if the unneeded region has a thin line shape, and otherwise, to correct the correction target region by the transplanting method. Thus, optimal correction in accordance with a shape of the unneeded region can be performed.

When the dilating method is used, the image correcting portion 30 corrects the image in the correction target region using the dilation process based on only the image data in the correction target region of the input image. A specific switching method of the correction method, and a specific correction method of the correction target region using the dilation process will be described later.

[Action Flowchart]

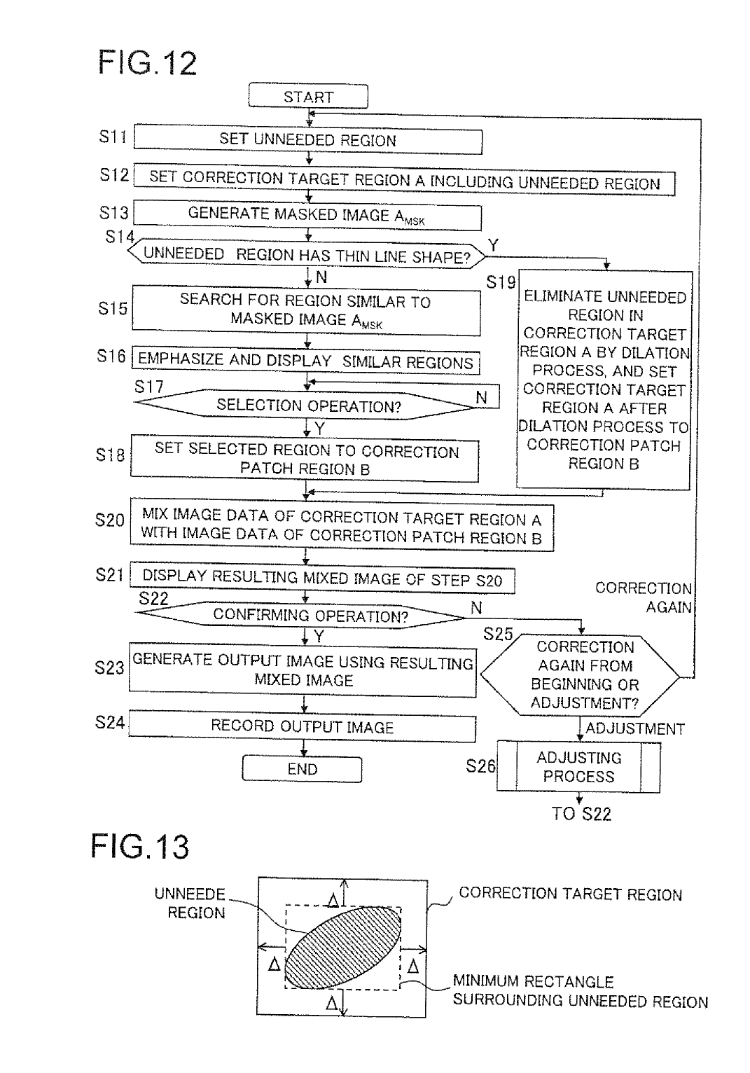

Next, an action flow of the image pickup apparatus 1 noted particularly to the action of the image correcting portion 30 is described. FIG. 12 illustrates a flowchart of this action flow.

In the reproduction mode, the user can control the display portion 16 to display a desired image recorded in the recording medium 15 or the like. If an unneeded object is depicted in the displayed image, the user performs a predetermined operation with the operation portion 17, and hence an action mode of the image pickup apparatus 1 changes to an unneeded object elimination mode as one type of the reproduction mode. The process of each step illustrated in FIG. 12 is a process performed in the unneeded object elimination mode. The input image and the output image in this unneeded object elimination mode are denoted by symbols I_{IN} and I_{OUT}, respectively.

In the unneeded object elimination mode, first, a surrounding part of the unneeded region in the input image I_{IN} is enlarged and displayed in accordance with a user's instruction, and in this state, the user performs the unneeded region specifying operation. The image correcting portion 30 sets the unneeded region based on the user's unneeded region specifying operation in Step S11. Then, the image correcting portion 30 sets a rectangular region including the unneeded region as a correction target region A in Step S12. As illustrated in FIG. 13, this rectangular region is a rectangular region obtained by increasing a size of the rectangle by Δpixel in each of the upper, lower, left, and right directions (Δ is a positive integer) from a reference rectangle circumscribed to the unneeded region, for example (in other words, a minimum rectangle that can surround the unneeded region). It is supposed that the center position of the correction target region A is the same as the center position of the unneeded region. A value of Δ may be a fixed value that is determined in advance. However, if an area of a region remaining after removing the unneeded region from the correction target region A is smaller than a predetermined reference area (for example, an area corresponding to 1024 pixels), it is possible to adjust a value of Δ so that the area becomes the reference area or larger.

After the correction target region A is set, the image correcting portion 30 generates the masked image A_{MSK} in Step S13 based on the correction target region A by the same method as that for generating the masked image 322 from the correction target region 320. The correction target region A and the masked image A_{MSK} correspond to the above-mentioned correction target region 320 and the masked image 322, respectively.

In the next Step S14, the image correcting portion 30 decides whether or not the unneeded region has a thin line shape. Specifically, first, the image in the correction target region A is converted into a binary image. In this binary image, pixels belonging to the unneeded region has a pixel value of zero, and other pixels has a pixel value of one. Further, in the direction of shrinking the unneeded region in the binary image, the dilation process (also called a morphology dilation process) is performed on the binary image. If the pixel (x, y) or at least one of eight pixels adjacent to the pixel (x, y) has a pixel value “1”, the pixel value of the pixel (x, y) is set to “1” by the dilation process. This dilation process is performed on the binary image a predetermined number of times (for example, five times), and if the area of the unneeded region in the obtained image is zero (namely, there is no region having the pixel value “0”), it is decided that the unneeded region has a thin line shape, and otherwise, it is decided that a shape of the unneeded region is not the thin line shape.

If it is decided that a shape of the unneeded region is not the thin line shape (N in Step S14), the process goes from Step S14 to Step S15. In Step S15, the image correcting portion 30 performs template matching using the masked image A_{MSK} as a template so as to search for the region similar to the masked image A_{MSK} from the input image I_{IN}. Then, in Step S16, a plurality of similar regions that were found are emphasized and displayed. In other words, as described above, individual correction patch region candidates in the input image I_{IN} is emphasized and displayed on the display screen so that the correction patch region candidates corresponding to the individual similar regions can be viewed and recognized (namely, the displayed image 360 as illustrated in FIG. 8B is displayed), and in Step S17, accepts the user's selection operation with the operation portion 17 for selecting one of the plurality of correction patch region candidates. Further, when the selection operation is performed, the selected correction patch region candidate is set to the correction patch region B in Step S18.

In addition, if there are a plurality of regions similar to the masked image A_{MSK}, it is possible to specify the maximum similarity among plurality of similarities determined corresponding to the plurality of similar regions, and to automatically set the correction patch region candidate for the similar region corresponding to the largest similarity to the correction patch region B without depending on the selection operation. In addition, if there is only one region similar to the masked image A_{MSK}, the process of Steps S16 and S17 is omitted, and the image region including the one similar region is set to the correction patch region B in Step S18.

Note that if no region similar to the masked image A_{MSK} is detected from the input image I_{IN} (namely, no image region having a similarity of the reference similarity or larger is detected from the input image I_{IN}), it is possible to inform the user of the fact so that the user can manually set the correction patch region B, or to stop the correction of the input image I_{IN}. The correction patch region B set in Step S18 corresponds to the correction patch region 340 described above, and the image data of the correction patch region B is stored in the memory of the image pickup apparatus 1.

On the other hand, if it is decided that the unneeded region has a thin line shape (Y in Step S14), the process goes from Step S14 to Step S19. When the process goes to Step S19, the image correcting portion 30 eliminates the unneeded region in the correction target region A by the dilation process. In other words, it is supposed that pixels in the unneeded region of the correction target region A are once deleted. Then, pixels and pixel signals in the unneeded region of the correction target region A are interpolated using pixels in the correction target region A surrounding the unneeded region, and pixel signals. This interpolation is realized by a known dilation process (also called a morphology dilation process). As a simple example, it is supposed that all pixels surrounding the unneeded region have the same pixel signal. Then, the same pixel signal is set to the pixel signals of pixels in the unneeded region of the correction target region A by the dilation process (namely, the unneeded region is filled with a single color). If it is decided that a shape of the unneeded region is a thin line shape, the correction target region A after the dilation process in Step S19 is set to the correction patch region B, and the image data of the correction target region A after the dilation process is stored as the image data of the correction patch region B in the memory of the image pickup apparatus 1.

After the process of Step S18 or S19, the process of Step S20 is performed. In Step S20, the image correcting portion 30 mixes the image data of the correction target region A with the image data of the correction patch region B so as to generate the resulting mixed image. This mixing method is the same as the mixing method of the correction target region 320 and the correction patch region 340 described above. In other words, it is supposed that a certain pixel position in the correction target region A is (x₁, y₁), and that a pixel position of a pixel in the correction patch region B corresponding to the pixel disposed at the pixel position (x₁, y₁) is (x₂, y₂). Then, a pixel signal P_{C} (x₁, y₁) at the pixel position (x₁, y₁) in the resulting mixed image is calculated by the following equation (2).

P_{C}(x₁,y₁)=(1−k_{MIX})+P_{A}(x₁,y₁)+k_{MIX}·P_{B}(x₂,y₂) (2)

Here, P_{A}(x₁, y₁) and P_{B}(x₂, y₂) respectively indicate pixel signals at the pixel positions (x₁, y₁) and (x₂, y₂) in the input image I_{IN}. It is supposed that on the input image I_{IN}, a position after the center position of the correction target region A is moved to the right side by Δx pixel and to the lower side by Δy pixel is the center position of the correction patch region B. Then, x₂=x₁+Δx and y₂=y₁+Δy are satisfied (Δx and Δy are integers). The pixel signals P_{A}(x₁, y₁) and P_{B}(x₂, y₂) are signals indicating luminance and color of pixels at the pixel position (x₁, y₁) and (x₂, y₂) in the input image I_{IN}. Similarly, the pixel signal P_{C}(x₁, y₁) is a signal indicating luminance and color of a pixel at the pixel position (x₁, y₁) in the output image I_{OUT}. However, if the adjusting process in Step S26 described later is performed, a specific signal value of the pixel signal P_{C}(x₁, y₁) can be changed. If each pixel signal is constituted of R, G, and B signals, the pixel signal P_{A}(x₁, y₁) and the P_{B}(x₂, y₂) should be mixed individually for each of R, G, and B signals so that the pixel signal P_{C}(x₁, y₁) is obtained. The same is true for the case where the pixel signal P_{A}(x₁, y₁) or the like is constituted of Y, U, and V signals.

The setting method and meaning of the coefficient k_{MIX} in the equation (2) are as described above. In other words, a value of the coefficient k_{MIX} in the equation (2) should be set in accordance with similarity DS₁ between image feature of the masked image A_{MSK} and image feature of the similar region included in the correction patch region B (image feature of the region similar to the masked image A_{MSK} included in the correction patch region B). The similarity DS₁ corresponds to the above-mentioned similarity DS. The image correcting portion 30 adjusts a value of the coefficient k_{MIX} in accordance with the similarity DS₁ so that a value of the coefficient k_{MIX} becomes larger as the similarity DS₁ is larger and that the value of the coefficient k_{MIX} becomes smaller as the similarity DS₁ is smaller. However, if the correction patch region B is set in Step S19, the coefficient k_{MIX} in the equation (2) may be a fixed value k_{FIX} that is determined in advance.

When the image data of the correction target region A is mixed with the image data of the correction patch region B, it is possible to use the same value of the coefficient k_{MIX} regardless of the pixel position to be mixed. However, it is possible to set the coefficient k_{MIX} smaller for a pixel closer to the periphery of the correction target region A in order to make a boundary between the corrected part and the uncorrected part be inconspicuous.

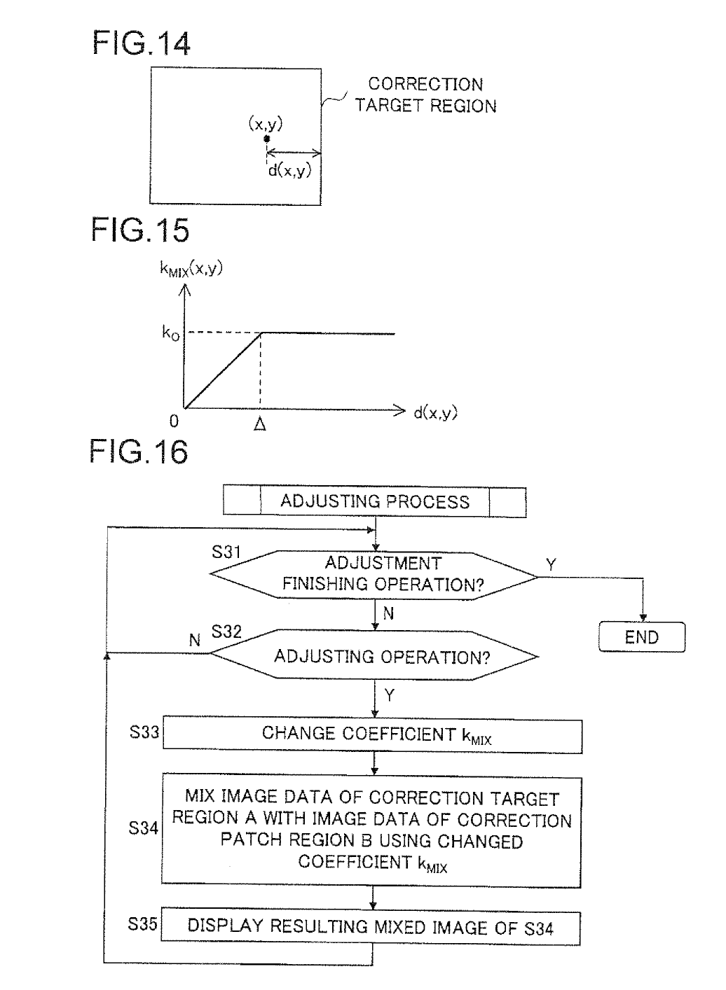

This is described more below. Here, the coefficient k_{MIX} for calculating the P_{C}(x, y) is expressed by k_{MIX}(x, y), and as illustrated in FIG. 14, a shortest distance between the pixel position (x, y) in the correction target region A and a periphery of the correction target region A is expressed by d(x, y). The d(x, y) is a length of a line segment having a shortest length among line segments connecting the pixel position (x, y) and the periphery of the correction target region A. In this case, k_{MIX}(x, y) should be set smaller as the distance d(x, y) is smaller. It is because that a pixel closer to the periphery of the correction target region A has a smaller coefficient k_{MIX} so that contribution of the image data of the correction target region A to the resulting mixed image is increased. Specifically, for example, as illustrated in FIG. 15, if d(x, y) is zero, k_{MIX}(x, y) should be set to zero. If 0<d(x, y)<Δ holds, k_{MIX}(x, y) should be linearly or nonlinearly increased from zero to k_{O} as d(x, y) increases from zero to Δ. If Δ≦d(x, y) holds, k_{MIX}(x, y) should be set to k_{O}. Here, k_{O} is a value of the coefficient k_{MIX} set in accordance with the above-mentioned similarity DS₁ or the fixed value k_{FIX}.

The resulting mixed image generated in the Step S20 is displayed on the display portion 16 in Step S21. In this case, it is preferred to display the resulting mixed image and the image in the correction target region A without the mixing correction in parallel on the display portion 16. Viewing the parallel display, the user can check effect of the correction and whether or not an evil influence has occurred due to the correction. While displaying the resulting mixed image, in Step S22, the image pickup apparatus 1 urges the user to confirm the correction content with a message display or the like.

In Step S22, if a predetermined confirming operation is performed with the operation portion 17, the process of Step S23 or S24 is performed so that the generating process of the output image I_{OUT} is completed. In Step S23, the image correcting portion 30 fits a latest resulting mixed image obtained in Step S20 or in Step S34 described later (see in FIG. 16) in the correction target region A of the input image I_{IN} so as to generate the output image I_{OUT}. In other words, the image in the correction target region A of the input image I_{IN} is replaced with the latest resulting mixed image obtained in Step S20 or S34 so that the output image I_{OUT} is generated. In Step S24, the image data of the obtained output image I_{OUT} is recorded in the recording medium 15. In this case, it is possible to store the image data of the output image I_{OUT} to overwrite the image data in the input image I_{IN} in accordance with a user's instruction, or it is possible to leave the image data of the input image I_{IN} in the recording medium 15 and to additionally record the image data of the output image I_{OUT} in the recording medium 15.

On the other hand, if the predetermined confirming operation is not performed with the operation portion 17 in Step S22, the process goes from Step S22 to Step S25. In Step S25, the image pickup apparatus 1 inquires by the message display or the like whether or not to perform the correction of the input image I_{IN} again from the beginning or to adjust the correction strength. If an operation for instructing to perform the correction again from the beginning is performed in Step S25, the process goes back to Step S11, and the process of Step S11 and following steps is performed again. If an operation for instructing to perform adjustment of the correction strength is performed in Step S25, the adjusting process of Step S26 is performed. After completion of the adjusting process, the process goes back to Step S22, and the process of Step S22 and following steps is performed again. Note that if a predetermined operation for instructing to finish is performed at any timing including a period in which the adjusting process of Step S26 is being performed, the action in the unneeded object elimination mode is finished.

FIG. 16 is a detailed flowchart of the adjusting process of Step S26. The adjusting process is constituted of the process of Steps S31 to S35. When the adjusting process of Step S26 is started, first, the process of Step S31 is performed. In Step S31, the image correcting portion 30 checks whether or not an adjustment finishing operation for instructing to finish the adjusting process is performed with the operation portion 17. If the adjustment finishing operation is performed, the adjusting process is finished, and the process goes back to Step S22. On the other hand, if the adjustment finishing operation is not performed, it is checked in the next Step S32 whether or not the adjusting operation is performed with the operation portion 17. If the adjusting operation is not performed, the process goes back from Step S32 to Step S31. If the adjusting operation is performed, the process goes from Step S32 to Step S33, and the image correcting portion 30 adjusts the correction strength for the correction target region A in accordance with the adjusting operation in Step S33. In other words, the image correcting portion 30 changes the coefficient k_{MIX} in accordance with the adjusting operation. Here, the adjusting operation is the same as that described above, and the method of changing the coefficient k_{MIX} in accordance with the adjusting operation is also as described above. In particular, if the coefficient k_{MIX} can be changed by the touch panel adjusting operation, the operability is very good.

In Step S34 after Step S33, in accordance with the equation (2) using the changed coefficient k_{MIX}, the image data of the correction target region A is mixed with the image data of the correction patch region B so that the resulting mixed image is generated. This generating method is the same as that in Step S20 of FIG. 12. The resulting mixed image generated in Step S34 is displayed on the display portion 16 in Step S35, and then the process goes back to Step S31, so as to repeat the process of Step S31 and following steps. Therefore, if the adjusting operation is performed again without the adjustment finishing operation, the adjusting of the correction strength (coefficient k_{MIX}) is continued.

Note that although different from the above description, after setting the correction patch region B in Step S18 or S19, it is possible to directly go to Step S26 and perform the adjusting process of Step S26 instead of performing the process of Steps S20 to S22. In this case, after setting the correction patch region B, the image pickup apparatus 1 displays the entire input image I_{IN} on the display screen or enlarges and displays the image in the correction target region A on the display screen (namely, a part of the input image I_{IN} is displayed on the display screen), while waiting that the adjustment finishing operation or the adjusting operation is performed. In this state, for example, if the user performs the above-mentioned vibration action of the touching member on the display screen (see FIG. 11), the vibration action is handled as an operation of instructing to correct the image in the correction target region A (image in the unneeded region), and the coefficient k_{MIX} is changed in the increasing direction from an initial value (for example, zero) as a start point (Step S33). As a result, the mixing correction is performed in Step S34, and the user can confirm the effect of eliminating the unneeded object by the display of the resulting mixed image in Step S35 on the display screen. In this case, with the setting in which the coefficient k_{MIX} is increased step by step by repeatedly performing the vibration action of the touching member, it is confirmed on the display screen that the unneeded object is gradually fading out as if unneeded description on a paper sheet is being faded out by an eraser.

[Internal Block of Image Correcting Portion]

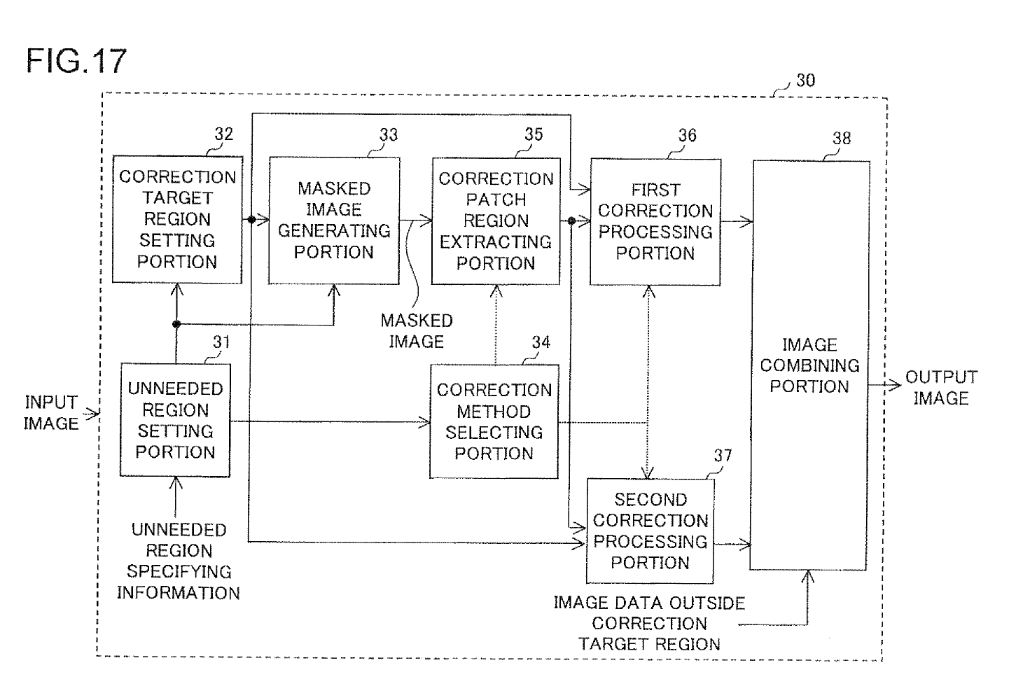

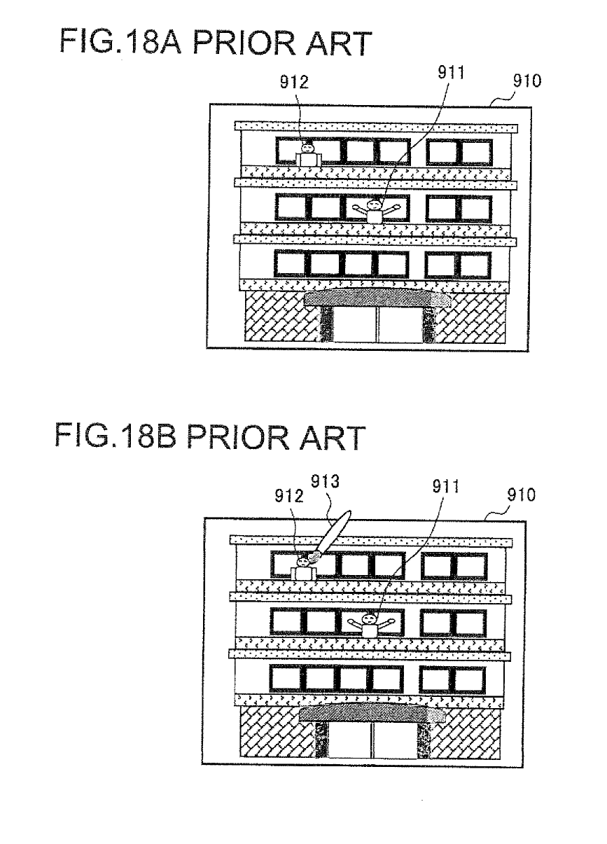

Next, an internal structure of the image correcting portion 30 is explained. FIG. 17 is an internal block diagram of the image correcting portion 30. The image correcting portion 30 includes individual portions denoted by numerals 31 to 38.

An unneeded region setting portion 31 sets the unneeded region in accordance with the above-mentioned unneeded region specifying operation. A correction target region setting portion 32 sets the correction target region including the set unneeded region (sets the above-mentioned correction target region 320 or correction target region A). A masked image generating portion 33 generates a masked image (the above-mentioned masked image 322 or masked image A_{MSK}) from the input image based on set contents of the unneeded region setting portion 31 and the correction target region setting portion 32.

A correction method selecting portion 34 decides whether or not the unneeded region has a thin line shape so as to select one of the transplanting method and the dilating method for correcting the correction target region (namely, the correction method selecting portion 34 performs the process of Step S14 in FIG. 12). A decision result and a selection result of the correction method selecting portion 34 are sent to a correction patch region extracting portion 35, a first correction processing portion 36, and a second correction processing portion 37.

If a shape of the unneeded region is not a thin line shape, the correction patch region extracting portion (correction patch region detecting portion) 35 detects and extracts the correction patch region (the above-mentioned correction patch region 340 or correction patch region B in Step S18) from the input image by template matching using the masked image. If a shape of the unneeded region is not a thin line shape, for example, the correction patch region extracting portion 35 performs the process of Steps S15 to S18 in FIG. 12 so as to extract and set the correction patch region. On the other hand, if a shape of the unneeded region is a thin line shape, the correction patch region extracting portion 35 generates the correction patch region by the dilation process performed on the correction target region. In other words, for example, if it is decided that a shape of the unneeded region is a thin line shape, the correction patch region extracting portion 35 performs the process of Step S19 in FIG. 12 so as to generate the correction patch region.

Each of the first correction processing portion 36 and the second correction processing portion 37 mixes the image data of the correction target region with the image data of the correction patch region so as to generate the resulting mixed image. However, the first correction processing portion 36 works only when the correction method selecting portion 34 decides that a shape of the unneeded region is not a thin line shape and the transplanting method is selected. The second correction processing portion 37 works only when the correction method selecting portion 34 decides that a shape of the unneeded region is a thin line shape and the dilating method is selected. In FIG. 17, the first correction processing portion 36 and the second correction processing portion 37 are illustrated as separated portions for convenience sake, but processes performed by them include a common process. Therefore, it is possible to integrate the first correction processing portion 36 and the second correction processing portion 37 to be one portion. Note that when the shape of the unneeded region is a thin line shape, the dilation process for generating the image data of the correction patch region may be performed by the second correction processing portion 37. An image combining portion 38 fits the resulting mixed image from the first correction processing portion 36 or the second correction processing portion 37 in the correction target region of the input image so as to generate the output image.

[Other Detection Method of Similar Region]

Although different from the above description, it is possible that the image correcting portion 30 searches for a region similar to the correction target region 320 as described below. First, after setting the correction target region 320, the image correcting portion 30 performs a blurring process of blurring the entire image region of the input image 310. In the blurring process, for example, spatial domain filtering using an averaging filter or the like is performed on all pixels of the input image 310 so that the entire input image 310 is blurred. After this, by template matching using an image Q₁ in the correction target region 320 after the blurring process as a template, an image Q₂ having image feature similar to image feature of the image Q₁ is detected and extracted from the input image 310 after the blurring process. It is supposed that the images Q₁ and Q₂ have the same shape and size.

If the similarity between the image Q₁ and the image of interest is a predetermined reference similarity or larger, it is decided that the image of interest has image feature similar to the image feature of the image Q₁. Similarity between images to be compared or image regions to be compared is determined from SSD or SAD of the pixel signal between images or image regions to be compared as described above.

The image region in which the image Q₂ is positioned is handled as a region similar to the correction target region 320. The image correcting portion 30 extracts the image region in which the image Q₂ is positioned as the correction patch region from the input image 310 before the blurring process. In other words, the image data in the image region in which the image Q₂ is positioned is extracted from the input image 310 before the blurring process, and the extracted image data is set as the image data of the correction patch region. Then, the image correcting portion 30 combines the image data of the correction target region 320 before the blurring process with the image data of the correction patch region so as to generate the resulting mixed image, and fits the generated resulting mixed image in the correction target region 320 of the input image 310 before the blurring process so as to generate the output image. In other words, the image correcting portion 30 replaces the image in the correction target region 320 of the input image 310 with the resulting mixed image so as to generate the output image.

With this structure of searching for the region similar to the correction target region using the blurring process, it is possible to omit the process of masking the unneeded region.

### Second Embodiment

A second embodiment of the present invention is described. The second embodiment and other embodiments described later are embodiments based on the first embodiment, and the techniques described in the second embodiment and other embodiments described later can be combined with the technique described in the first embodiment as long as no contradiction occurs. In addition, the description in the first embodiment can be applied to the second embodiment and other embodiments described later concerning matters not noted in the second embodiment and other embodiments described later as long as no contradiction occurs.

In the first embodiment, there is described that the touch panel operation may be used for the unneeded region specifying operation for specifying the unneeded region (image region in which image data of the unneeded object exists). In the second embodiment, there is described a more specific example of the unneeded region specifying operation using the touch panel operation. It is possible to use the unneeded region specifying operation in the second embodiment so as to set the unneeded region in any other embodiments. The setting of the unneeded region includes setting of position, size, shape, and contour of the unneeded region in the input image (the same is true for any other embodiments). In the second embodiment and other embodiments described later, for specific description, it is supposed that the touching member in the touch panel operation is a user's finger.

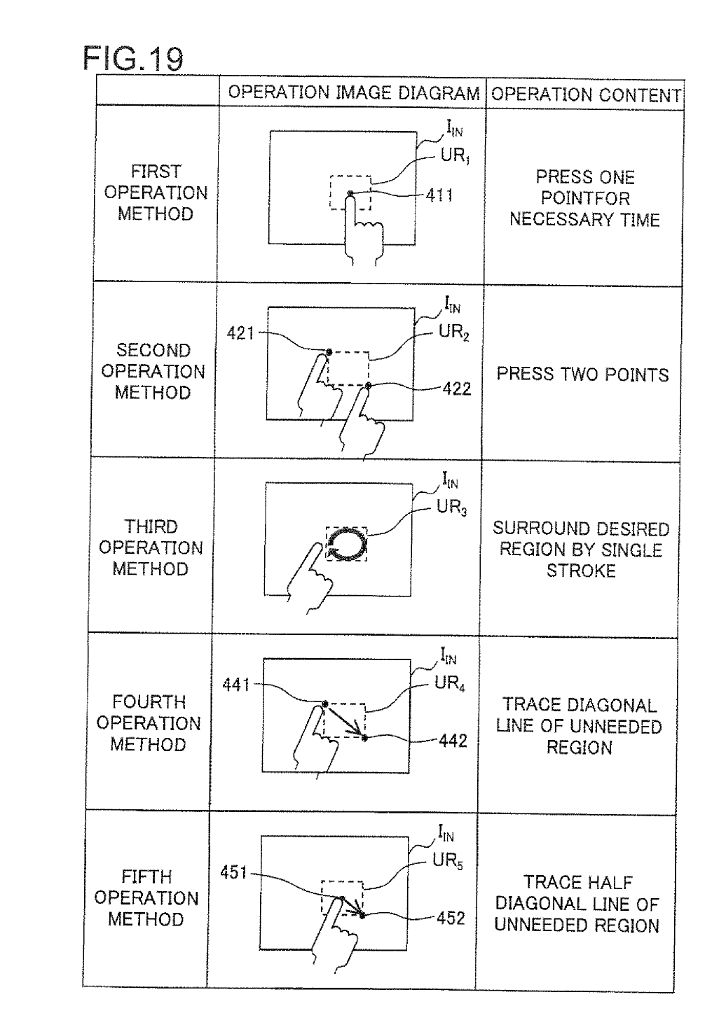

The image pickup apparatus 1 accepts the unneeded region specifying operation in a state where the input image to the image correcting portion 30 of FIG. 2 is displayed on the display screen of the display portion 16. The unneeded region setting portion 31 of FIG. 17 can set the unneeded region in accordance with unneeded region specifying information indicating content of the unneeded region specifying operation. A user who wants to eliminate the unneeded object can performed the unneeded region specifying operation by any one of the following first to fifth operation methods, for example. FIG. 19 illustrates an outline of the unneeded region specifying operation by the first to fifth operation methods. When the input of the unneeded region specifying operation is accepted, the input image I_{IN} is displayed on the display screen. The entire input image I_{IN} may be displayed on the display screen, or a part of the input image I_{IN} may be enlarged and displayed in accordance with a user's instruction. In FIG. 19, the regions enclosed by broken lines denoted by symbols UR₁ to UR₅ indicate rectangular unneeded regions set in the input image I_{IN} by the first to fifth operation methods, respectively.

The first operation method is described below. The touch panel operation according to the first operation method is an operation of pressing a desired position 411 in the input image I_{IN} on the display screen for a necessary period of time by a finger. The unneeded region setting portion 31 can set the position 411 at the center position of the unneeded region UR₁ and can set a size of the unneeded region UR₁ in accordance with the period of time for which the finger is pressed and held on the position 411. For instance, a size of the unneeded region UR₁ can be increased as the time increases. In the first operation method, an aspect ratio of the unneeded region UR₁ can be determined in advance.

The second operation method is described below. The touch panel operation according to the second operation method is an operation of pressing desired positions 421 and 422 in the input image I_{IN} on the display screen by a finger. The positions 421 and 422 are different positions. The positions 421 and 422 may be pressed by a finger in order, or the positions 421 and 422 may be pressed simultaneously by two fingers. The unneeded region setting portion 31 can set the rectangular region having the positions 421 and 422 on both ends of its diagonal line as the unneeded region UR₂.

The third operation method is described below. The touch panel operation according to the third operation method is an operation of touching the display screen with a finger and encircling a desired region (by the user) in the input image I_{IN} on the display screen with the finger. In this case, the finger tip drawing a figure to encircle the desired region does not separate from the display screen. In other words, the user's finger draws the figure encircling the desired region by a single stroke. The unneeded region setting portion 31 can set the desired region encircled by the finger or a rectangular region including the desired region as the unneeded region UR₃.

The fourth operation method is described below. The touch panel operation according to the fourth operation method is an operation of touching the display screen with a finger and moving the finger to trace a diagonal line of the region to be the unneeded region UR₄. Specifically, for example, the user touches a desired position 441 with a finger in the input image I_{IN} on the display screen, and then moves the finger from the position 441 to a position 442 in the input image I_{IN} while keeping the contact between the finger and the display screen. After that, the user releases the finger from the display screen. In this case, the unneeded region setting portion 31 can set the rectangular region having the positions 441 and 442 on both ends of its diagonal line as the unneeded region UR₄.

The fifth operation method is described below. The touch panel operation according to the fifth operation method is an operation of touching the display screen with a finger and moving the finger to trace a half of a diagonal line of the region to be the unneeded region UR₅. Specifically, for example, the user touches a desired position 451 with a finger in the input image I_{IN} on the display screen, and then moves the finger from the position 451 to a position 452 in the input image I_{IN} while keeping the contact between the finger and the display screen. After that, the user releases the finger from the display screen. In this case, the unneeded region setting portion 31 can set the center position of the unneeded region UR₅ to the position 451 and set a vertex of the unneeded region UR₅ as the rectangular region to the position 452.

Note that it is supposed that the unneeded region URᵢ is a rectangular region in the above description, but the unneeded region URᵢ may be a region having a shape other than a rectangle and may be any region as long as it is a closed region (i is an integer). For instance, a shape of the unneeded region URᵢ may be a circle or a polygon, or a closed region enclosed by an arbitrary curve may be the unneeded region URᵢ. In addition, the above-mentioned first to fifth operation methods are merely examples, and other various touch panel operations may be adopted for the user to specify the unneeded region.

### Third Embodiment

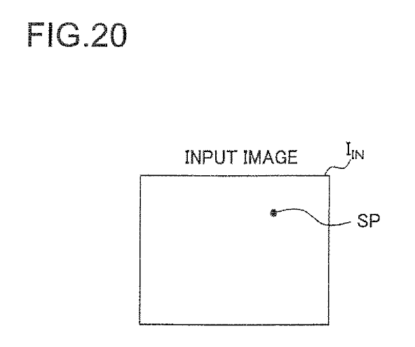

A third embodiment of the present invention is described. In the third embodiment, a method of setting the unneeded region using an image analysis is exemplified. Using the method of setting the unneeded region according to the third embodiment, it is possible to set the unneeded region in any other embodiment. Note that in the following description, an operation with a button (not shown) or the like disposed in the operation portion 17 of FIG. 1 is referred to as a button operation for convenience sake. In a state where the input image I_{IN} to the image correcting portion 30 of FIG. 2 is displayed on the display screen, the user can specify a desired position SP in the input image I_{IN} by the touch panel operation or the button operation (see FIG. 20). Hereinafter, the position SP is referred to as a specified position SP. The specified position SP is a position of a part of the unneeded object on the input image I_{IN}. The information indicating the specified position SP is input as the unneeded region specifying information to the unneeded region setting portion 31 (see FIG. 17).

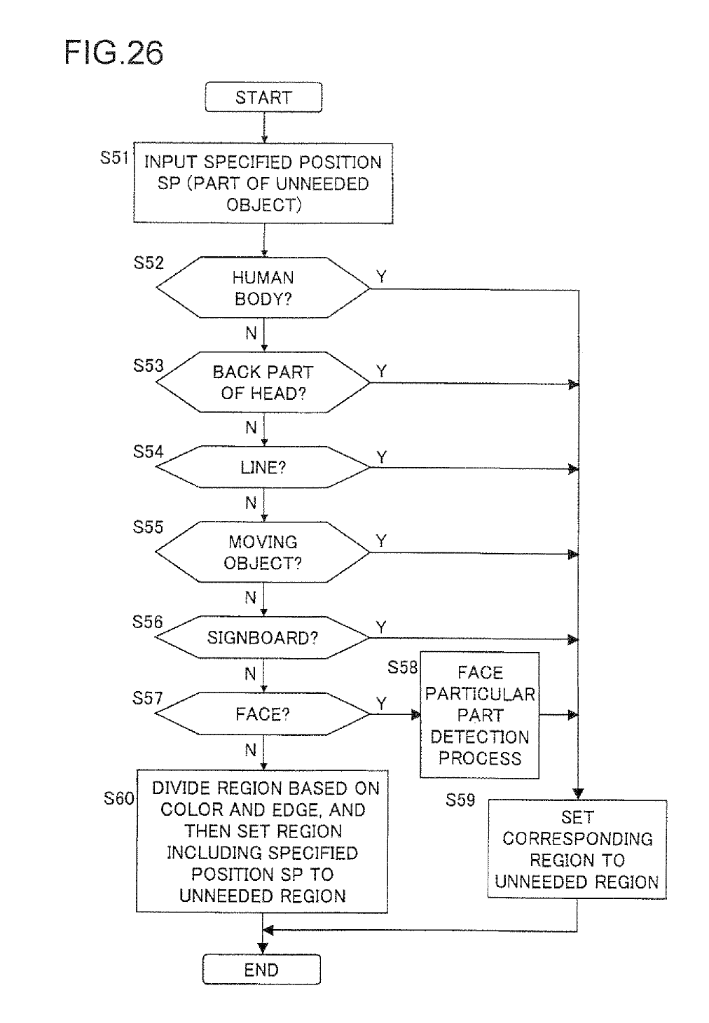

The unneeded region setting portion 31 regards the object including the specified position SP as an unneeded object so as to set the image region including the specified position SP in the input image I_{IN} as the unneeded region (namely, the specified position SP becomes a position of a part of the unneeded region). In this case, the unneeded region setting portion 31 utilizes the image analysis based on the image data of the input image I_{IN} so as to estimates a contour (outer frame) of the unneeded object including the specified position SP, and can set the internal region of the estimated contour of the unneeded object to the unneeded region. Prior to describing a setting action procedure of the unneeded region (see FIG. 26), an example of elemental technology of the above-mentioned image analysis is described.

The above-mentioned image analysis can include a human body detection process of detecting a human body existing in the input image I_{IN}. If a specified position SP exists in the internal region of the human body on the input image I_{IN}, the unneeded region setting portion 31 can detects a human body region from the input image I_{IN} by the human body detection process based on the image data of the input image I_{IN} so as to set the human body region including the specified position SP to the unneeded region. Detection of the human body region includes detection of position, size, shape, contour, and the like of the human body on the input image I_{IN}. The human body region is an image region in which the image data of the human body exists, and the internal region of the contour of the human body can be regarded as the human body region. Because the method of the human body detection process is well known, the description of the process of method is omitted.

The above-mentioned image analysis can include a head back detection process of detecting a back part of head (of a human body) existing in the input image I_{IN}. If the specified position SP exists in the internal region of the back part of head on the input image I_{IN}, the unneeded region setting portion 31 detects a back part region of head from the input image I_{IN} by the head back detection process based on the image data of the input image I_{IN}, and can set the back part region of head including the specified position SP to the unneeded region. Detection of the back part region of head includes detection of position, size, shape, contour, and the like of the back part of head on the input image I_{IN}. The back part region of head is an image region in which the image data of the back part of head exists, and the internal region of the contour of the back part of head can be regarded as the back part region of head. As a method of detecting the back part of head, a known method can be used.

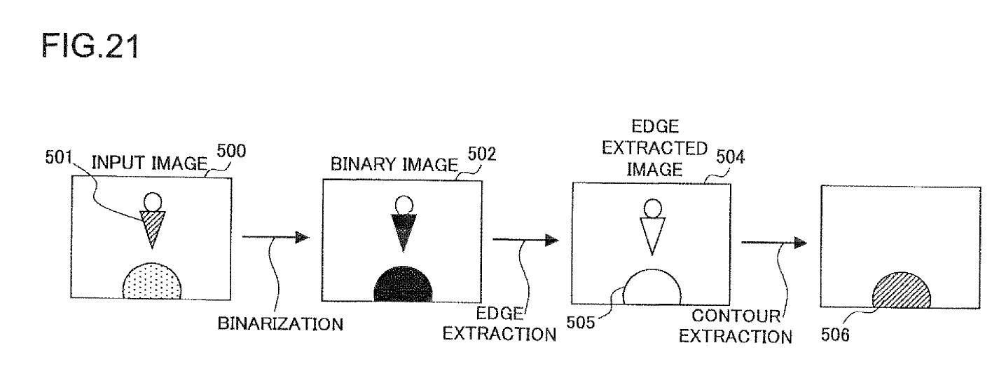

With reference to FIG. 21, an example of the head back detection process is described. FIG. 21 illustrates an input image 500 as an example of the input image I_{IN}. It is supposed that the input image 500 is an image obtained by photographing a celebrity 501 in a crowd of people. In FIG. 21, a semicircular part filled with dots on the lower side of the input image 500 indicates a back part of head of other person standing between the image pickup apparatus 1 and the celebrity 501 when the input image 500 is taken. In the head back detection process, first, the pixel signals of the input image 500 are binarized so as to convert the input image 500 into a binary image 502. Then, edges (contours of objects) are extracted from the binary image 502 so as to generate an edge extracted image 504. By performing spatial domain filtering using an edge extraction filter (differential filter or the like) on the binary image 502, the edge extracted image 504 can be obtained. The unneeded region setting portion 31 extracts an arcuate contour 505 existing in the lower side region of the edge extracted image 504, and can detect the image region in the contour 505 (namely, a hatched region 506 in FIG. 21) as the back part region of head. In the image, the upper and lower direction corresponds to gravity direction, and the lower side region of the edge extracted image 504 means the region on the earth side in the edge extracted image 504 (for example, it means the region closest to the earth among a plurality of image regions obtained by dividing the edge extracted image 504 uniformly into a plurality of image regions along the horizontal direction).

The above-mentioned image analysis can include a line detection process of detecting a linear object existing in the input image I_{IN}. The linear object means an object having a linear shape (particularly, for example, a straight line shape), which may be, for example, a net or an electric wire. If the specified position SP exists in the internal region of the linear object on the input image I_{IN}, the unneeded region setting portion 31 detects a linear region from the input image I_{IN} by the line detection process based on the image data of the input image I_{IN}, and can set the linear region including the specified position SP to the unneeded region. Detection of the linear region includes detection of position, size, shape, contour, and the like of the linear object on the input image I_{IN}. The linear region is an image region in which the image data of the linear object exists, and the internal region of the contour of the linear object can be regarded as the linear region. As a method of detecting the linear object, a known method can be used.

For instance, a linear object can be detected from the input image I_{IN} by straight line detection using Hough transform. Here, it is supposed that the straight line includes a line segment. If a plurality of linear objects exist in the input image I_{IN}, it is possible to combine the plurality of linear objects to regard them as one unneeded object, and to set the combined region of the plurality of linear regions as for the plurality of linear objects to the unneeded region.

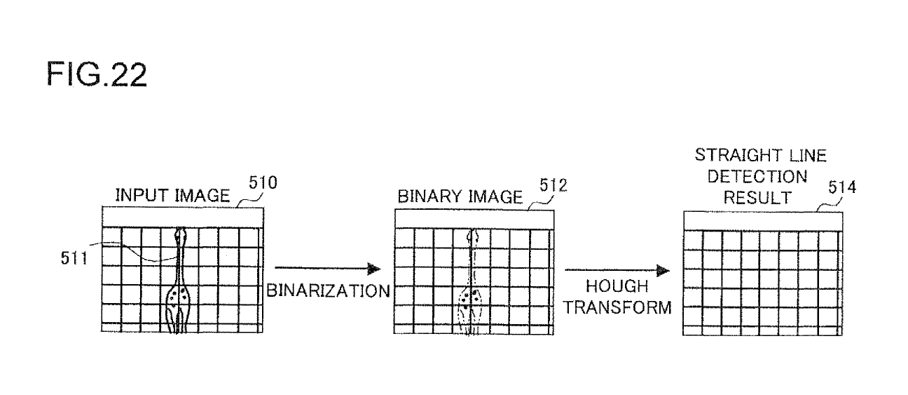

With reference to FIG. 22, an example of the line detection process is described. FIG. 22 illustrates an input image 510 as an example of the input image I_{IN}. The input image 510 is supposed to be an image obtained by photographing a giraffe 511 through a wire net. In the input image 510 of FIG. 22, a plurality of line segments arranged like a grid indicate the wire net. In the line detection process, pixel signals of the input image 510 are binarized so that the input image 510 is converted into a binary image 512, and Hough transform is performed on the binary image 512 so that a straight line detection result 514 is obtained. Linear regions of the straight lines detected by Hough transform performed on the binary image 512 are combined, and hence the combined region can be set to the unneeded region.

Note that it is possible to constitute the image pickup apparatus 1 so that the user can specify the direction of the straight line (linear object) to be included in the unneeded region. For instance, it is supposed that in a state where the input image 510 is displayed on the display screen, the user touches a part of the wire net in the input image 510 as the specified position SP with a finger, and then moves the finger in the horizontal direction of the input image 510 (horizontal direction of the display screen) while keeping the contact state between the finger and the display screen. Then, it is possible to include only linear objects extending in the horizontal direction to the unneeded region (in other words, it is possible to exclude linear objects extending in the vertical direction from the unneeded region).

The above-mentioned image analysis may include a moving object detection process for detecting a moving object existing in the input image I_{IN}. If the specified position SP exists in an internal region of the moving object on the input image I_{IN}, the unneeded region setting portion 31 detects the moving object region from the input image I_{IN} by the moving object detection process based on the image data of the input image I_{IN}, and can set the moving object region including the specified position SP to the unneeded region. Detection of the moving object region includes detection of position, size, shape, contour, and the like of the moving object on the input image I_{IN}. The moving object region is an image region in which the image data of the moving object exists, and the internal region of the contour of the moving object can be regarded as the moving object region.

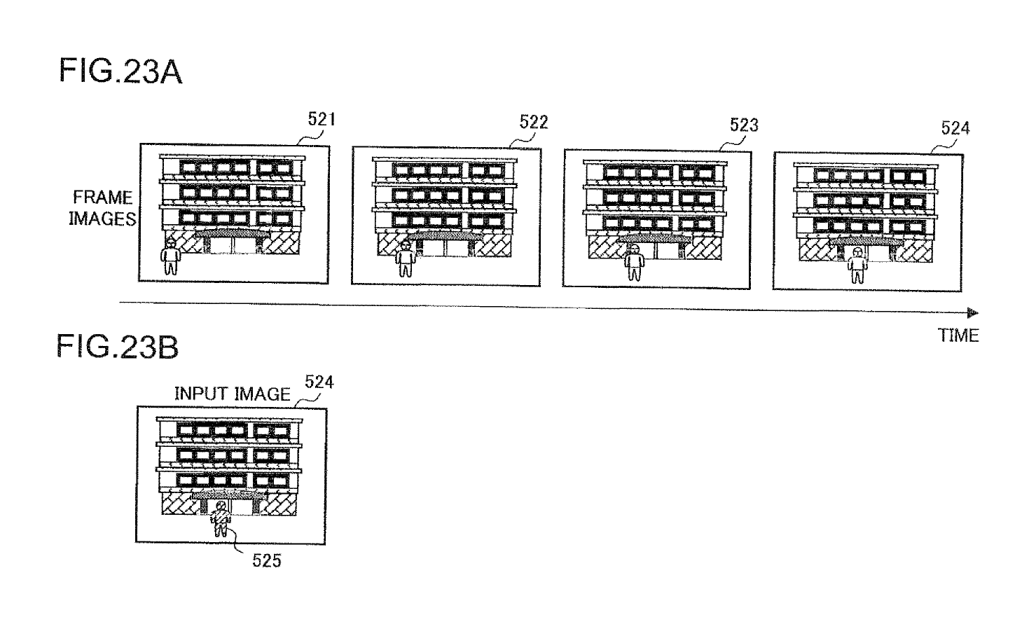

The moving object detection process can be performed by using a plurality of frame images arranged in a time sequence including the input image I_{IN}. With reference to FIGS. 23A and 23B, an example of the moving object detection process is described. The image pickup apparatus 1 can take frame images one after another by the sequential photography at a predetermined frame period, and can record a frame image after a predetermined shutter operation as the input image I_{IN} in the recording medium 15 (see FIG. 1). Now, it is supposed that a frame image 524 illustrated in FIGS. 23A and 23B is recorded as the input image I_{IN} in the recording medium 15, and it is supposed that frame images 521, 522, 523, and 524 are taken in this order. The image processing portion 14 (for example, the unneeded region setting portion 31) determines a difference between the frame images 521 and 524, a difference between the frame images 522 and 524, and a difference between the frame images 523 and 524 before or after taking the frame image 524. Then, based on the determined differences, a moving object on the moving image constituted of the frame images 521 to 524 is detected, and a moving object and a moving object region 525 on the frame image 524 are detected (see FIG. 23B). The moving object is an object that is moving on the moving image including the frame image 524.

When recording the frame image 524 in the recording medium 15, the image pickup apparatus 1 also records the moving object region information specifying the moving object region 525 on the frame image 524 in a manner associated with image data of the frame image 524 in the recording medium 15. When the frame image 524 is input as the input image I_{IN} to the image correcting portion 30 (see FIG. 2), the moving object region information read from the recording medium 15 is given to the unneeded region setting portion 31. Thus, the unneeded region setting portion 31 can recognize the moving object region 525 on the input image I_{IN} and can set the moving object region 525 to the unneeded region if the specified position SP is in the moving object region 525.

Note that in the above-mentioned example, the moving object detection is performed by using the frame image 524 and the three frame images taken before the frame image 524. However, it is possible to perform the moving object detection by using the frame image 524 and one or more frame images taken before the frame image 524, or by using the frame image 524 and one or more frame images taken after the frame image 524. In addition, if image data of the frame images taken before and after the frame image 524 are also recorded in the recording medium 15 in such a case where the frame image 524 is a part of a moving image recorded in the recording medium 15, it is possible to detect the moving object region 525 by using the recorded data in the recording medium 15 when the frame image 524 is input as the input image I_{IN} to the image correcting portion 30.

The above-mentioned image analysis can include a signboard detection process of detecting a signboard existing in the input image I_{IN}. If the specified position SP is in the internal region of the signboard on the input image I_{IN}, the unneeded region setting portion 31 detects the signboard region from the input image I_{IN} by the signboard detection process based on the image data of the input image I_{IN}, and can set the signboard region including the specified position SP to the unneeded region. Detection of the signboard region includes detection of position, size, shape, contour, and the like of the signboard on the input image I_{IN}. The signboard region is an image region in which the image data of the signboard exists, and the internal region of the contour of the signboard can be regarded as the signboard region.

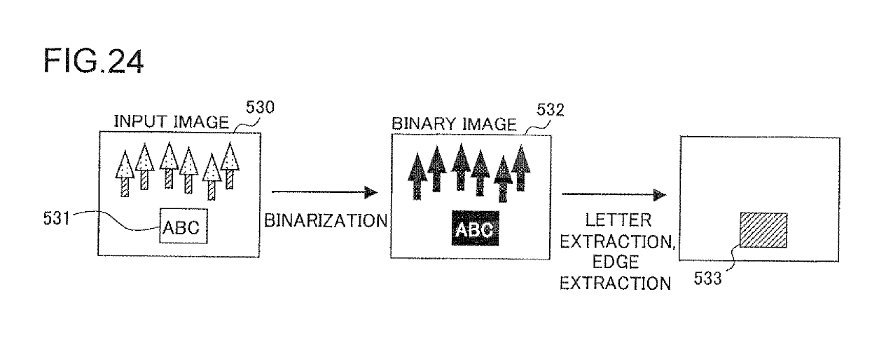

With reference to FIG. 24, an example of the signboard detection process is described. FIG. 24 illustrates an input image 530 as an example of the input image I_{IN}. The input image 530 is an image obtained by photographing a forest and a signboard 531 placed in front of the forest. In the signboard detection process, a known letter extraction process is used for extracting letters in the input image 530, and a contour surrounding a group of the extracted letters is extracted as a contour of the signboard. More specifically, for example, pixel signals of the input image 530 are binarized so that the input image 530 is converted into a binary image 532. Then, letters are extracted from the binary image 532, and a contour surrounding the extracted letters is extracted as a contour of the signboard 531 (outer frame of the signboard 531) based on a result of an edge extraction process (contour extraction process) performed on the binary image 532. Thus, the image region in the extracted contour (hatched region 533 in FIG. 24) is detected as the signboard region.

The above-mentioned image analysis can include a face detection process of detecting a face existing in the input image I_{IN} and a face particular part detection process of detecting a spot existing in the face. If the specified position SP exists in the internal region of the face on the input image I_{IN}, the unneeded region setting portion 31 detects a face region including the specified position SP from the input image I_{IN} by the face detection process based on the image data of the input image I_{IN}. Detection of the face region includes detection of position, size, shape, contour, and the like of the face on the input image I_{IN}. The face region is an image region in which the image data of the face exists, and the internal region of the contour of the face can be regarded as the face region.

The face region including the specified position SP is referred to as a specified face region. When the specified face region is detected, the unneeded region setting portion 31 detects a spot in the specified face region by the face particular part detection process based on the image data of the input image I_{IN}. Using the face particular part detection process, it is possible to detect not only a spot but also a blotch, a wrinkle, a bruise, a flaw, or the like. Further, it is possible to set the image region in which image data of a spot, a blotch, a wrinkle, a bruise, a flaw, or the like exists to the unneeded region.

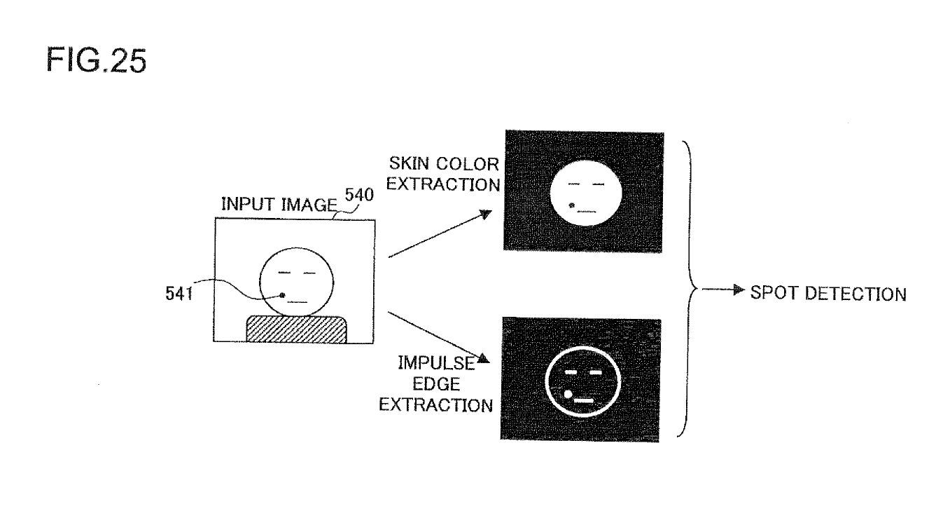

With reference to FIG. 25, an example of the spot detection method is described. FIG. 25 illustrates an input image 540 as an example of the input image I_{IN}. The face of the person on the input image 540 has a spot 541. The unneeded region setting portion 31 extracts a skin color region on the input image 540, and then performs an dilation process in the direction in which the region other than the skin color region existing inside the skin color region (including the region of the spot 541) shrinks (in other words, the region other than the skin color region existing inside the skin color region is shrunk). On the other hand, an impulse-like edge is extracted from the input image 540 by the edge extraction process, and a common region between the region in which the impulse-like edge exists and the skin color region after the dilation process can be detected as the image region in which the image data of the spot 541 exists. Note that it is possible to compare a luminance value of each pixel in the specified face region with a predetermined threshold value, and to detect a part in which a predetermined number or more of pixels having a luminance value of the threshold value or lower are gathered as the spot.

With reference to a flowchart of FIG. 26, setting action procedure of the unneeded region is described. First, the user inputs the above-mentioned specified position SP to the image pickup apparatus 1 using the touch panel operation or the button operation (Step S51). When the specified position SP is input, the unneeded region setting portion 31 decides whether or not the object including the specified position SP in the input image I_{IN} is a human body, by using the human body detection process (Step S52). If it is decided that the object including the specified position SP is a human body, the human body region including the specified position SP detected using the human body detection process is set to the unneeded region (Step S59).

If it is decided that the object including the specified position SP is not a human body, the unneeded region setting portion 31 decides whether or not the object including the specified position SP in the input image I_{IN} is a back part of head by using the head back detection process (Step S53). Then, if it is decided that the object including the specified position SP is a back part of head, the back part region of head including the specified position SP detected by using the head back detection process is set to the unneeded region (Step S59).

If it is decided that the object including the specified position SP is not a back part of head, the unneeded region setting portion 31 decides whether or not the object including the specified position SP in the input image I_{IN} is a linear object by using the line detection process (Step S54). Then, if it is decided that the object including the specified position SP is a linear object, the linear region including the specified position SP detected by using the line detection process is set to the unneeded region (Step S59).

If it is decided that the object including the specified position SP is not a linear object, the unneeded region setting portion 31 decides whether or not the object including the specified position SP is a moving object in the input image I_{IN} by using the above-mentioned moving object region information or the moving object detection process (Step S55). Then, if it is decided that the object including the specified position SP is a moving object, the moving object region including the specified position SP indicated by the moving object region information or detected by using the moving object detection process is set to the unneeded region (Step S59).

If it is decided that the object including the specified position SP is not a moving object, the unneeded region setting portion 31 decides whether or not the object including the specified position SP in the input image I_{IN} is a signboard by using the signboard detection process (Step S56). Then, if it is decided that the object including the specified position SP is a signboard, the signboard region including the specified position SP detected by using the signboard detection process is set to the unneeded region (Step S59).

If it is decided that the object including the specified position SP is not a signboard, the unneeded region setting portion 31 decides whether or not the object including the specified position SP in the input image I_{IN} is a face by using the face detection process (Step S57). Then, if it is decided that the object including the specified position SP is a face, the face region including the specified position SP detected by using the face detection process is extracted as the specified face region. Further, using the above-mentioned face particular part detection process (Step S58), the image region in which image data of a spot or the like exists is set to the unneeded region (Step S59).

If it is decided that the object including the specified position SP is not any one of a human body, a back part of head, a linear object, a moving object, a signboard, and a face, the unneeded region setting portion 31 divides the entire image region of the input image I_{IN} into a plurality of image regions by a known region dividing process based on the image data (color information and edge information) of the input image I_{IN}, and sets the image region including the specified position SP among the obtained plurality of image regions to the unneeded region (Step S60).

Note that if there is a human face in the input image I_{IN}, it is possible to decide which one of the human body region and the spot region is to be set to the unneeded region in view of a size of the face. For instance, if a human face exists in the input image I_{IN}, and if the specified position SP is included in the face, a face region size F_{SIZE} of the face in the input image I_{IN} is detected. Then, if the size F_{SIZE} is smaller than a predetermined reference value, the human body region including the specified position SP may be set to the unneeded region. On the other hand, if the size F_{SIZE} is the predetermined reference value or larger, the face particular part detection process may be applied to the specified face region including the specified position SP, and the image region in which the image data of a spot or the like in the specified face region exists may be set to the unneeded region. In addition, in the action example illustrated in FIG. 26, the process of Steps S52 to S57 is performed in this order, but it is possible to change the execution order of the process of Steps S52 to S57 to an arbitrary order.

In the third embodiment, the unneeded region specifying operation to be performed by the user is finished by the operation of inputting the specified position SP. In other words, for example, the unneeded region is automatically set only by touching a part of the unneeded object on the display screen by a finger, and hence user's operation load can be reduced.

### Fourth Embodiment

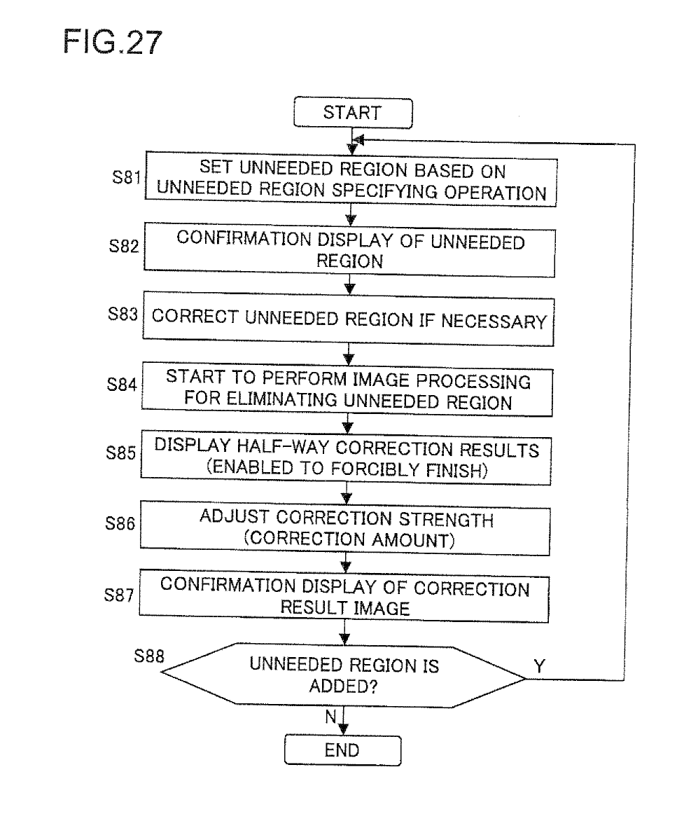

A fourth embodiment of the present invention is described. FIG. 27 is an action flowchart of the image pickup apparatus 1 according to the fourth embodiment. The image pickup apparatus 1 can sequentially perform process of Steps S81 to S88 in the unneeded object elimination mode.

First, in Step S81, the unneeded region is set in the input image I_{IN} based on the unneeded region specifying operation by the user. The unneeded region can be set by using the method described in any other embodiment. In the next Step S82, the display portion 16 performs confirmation display of the set unneeded region. In other words, while performing the entire display or a partial display of the input image I_{IN}, the unneeded region is clearly displayed on the display screen so that the user can recognize the set unneeded region visually(for example, a blinking display or a contour emphasized display of the unneeded region is performed). In Step S83, the user can instruct to correct the once set unneeded region in accordance with necessity. This correction is realized by user's manual operation or by rerun of the unneeded region specifying operation, for example.

After the user confirms the unneeded region, if the user performs a predetermined operation, the image correcting portion 30 starts to perform the image processing for eliminating the unneeded region in Step S84. The image processing for eliminating the unneeded region is the same as that described above in the first embodiment. In other words, for example, it is possible to use the process of Steps S12 to S20 in FIG. 12 as the image processing for eliminating the unneeded region.

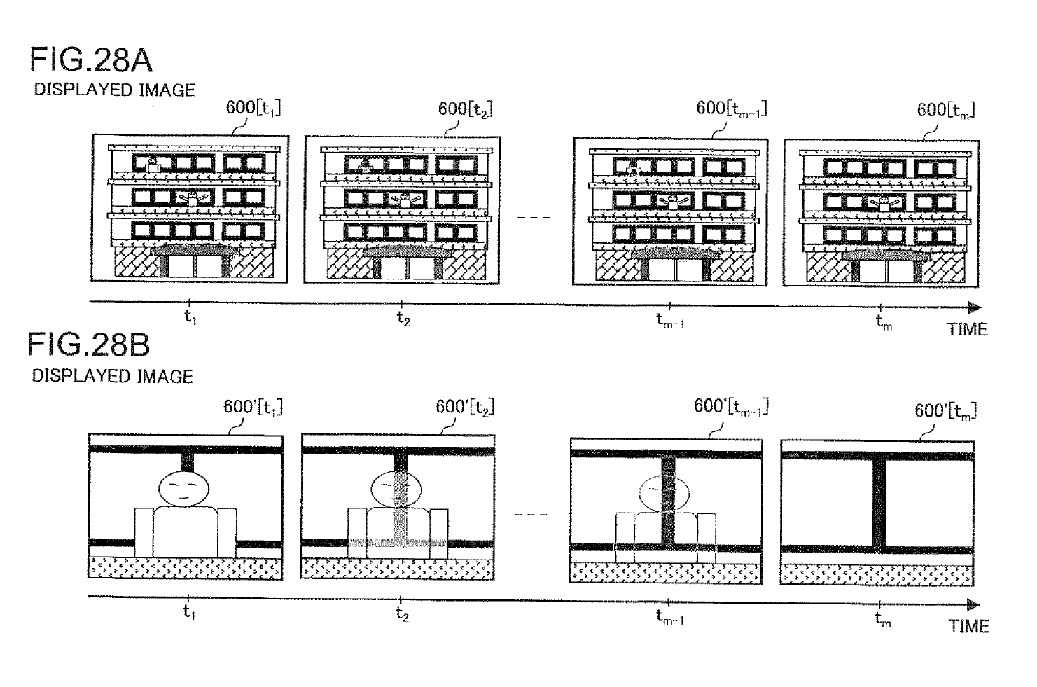

After starting the image processing for eliminating the unneeded region, the display portion 16 sequentially displays half-way correction results in Step S85. This display is described with reference to FIGS. 28A and 28B. For specific description, it is supposed that the input image 310 of FIG. 4 is the input image I_{IN}, the image region surrounded by the contour of the person 312 is the unneeded region, and the region 320 is the correction target region. In addition, a symbol tᵢ is used for indicating time points (i is an integer). Time point tᵢ₊₁ is later than time point tᵢ.

An image 600[tᵢ] illustrated in FIG. 28A is an image displayed on the display screen at time point tᵢ. In Step S85, the display portion 16 sequentially displays the images 600[t₁], 600[t₂], 600[tₘ₋₁], and 600[tₘ]. Symbol m is an integer of three or larger. The image 600[t₁] is the input image I_{IN} before the image processing for eliminating the unneeded region, namely the input image 310 itself. Supposing that the variable i is two or larger, the image 600[tᵢ] corresponds to the output image I_{OUT} obtained by performing the process of Steps S12 to S23 of FIG. 12 in the state where a value VALᵢ is substituted into the coefficient k_{MIX} (see FIG. 9). Here, the value VALᵢ₊₁ is larger than the value VALᵢ with respect to an arbitrary integer i. Here, the value VALᵢ is larger than zero, and the value VALₘ is one.

Note that it is possible to display the image 600′[tᵢ] of FIG. 28B instead of the image 600[tᵢ] of FIG. 28A at time point tᵢ. In other words, it is possible to sequentially display the images 600′[t₁], 600′[t₂], . . . , 600′[tₘ₋₁], and 600′[tₘ] in Step S85. The image 600′[t₁] is the image in the correction target region before the image processing for eliminating the unneeded region, namely the image in the correction target region in the input image 310. Supposing that the variable i is two or larger, the image 600′[Tᵢ] corresponds to the resulting mixed image obtained by performing the process of Steps S12 to S20 of FIG. 12 in the state where the value VALᵢ is substituted into the coefficient k_{MIX} (see FIG. 9).

In this way, the image correcting portion 30 (the first correction processing portion 36 or the second correction processing portion 37 in FIG. 17) divides the correction of the image in the correction target region into a plurality of corrections so as to performs the corrections step by step (the value of the coefficient k_{MIX} is gradually increased while performing the corrections step by step). The correction result images 600[t₂] to 600[tₘ] obtained by performing the corrections step by step (or 600′[t₂] to 600′[tₘ]) are sequentially output to the display portion 16 and are displayed. Because VALᵢ<VALᵢ₊₁ holds, it is possible to obtain an image effect in which the unneeded object fades out gradually on the display screen as time passes.

Note that the user can also finish the display in Step S85 in a forced manner by performing a predetermined forced finish operation to the image pickup apparatus 1 before time point tₘ.

In Step S86 after Step S85, the image pickup apparatus 1 accepts a user's adjustment instruction for the correction strength (correction amount), and adjusts the correction strength in accordance with the adjustment instruction. As a method of adjusting the correction strength, first and second adjust methods are exemplified.

The first adjust method is described. If the above-mentioned forced finish operation is not performed, the image 600[tₘ] or 600′[tₘ] is displayed when the process goes from Step S85 to Step S86 (see FIG. 28A or 28B). In this state, the user can perform the touch panel adjusting operation described above in the first embodiment, and the image correcting portion 30 can adjust the correction strength in accordance with content of the touch panel adjusting operation. More specifically, for example, when the touch panel adjusting operation is performed, the value of the coefficient k_{MIX} is decreased from one in accordance with the number of vibration, for example, of the touching member described above in the first embodiment, and the correction result image obtained by using the decreased coefficient k_{MIX} is displayed in real time. If the decreased value of the coefficient k_{MIX} is value VALₘ₋₁, for example, the correction result image obtained by using the decreased coefficient k_{MIX} is the image 600[tₘ₋₁] or 600′[tₘ₋₁] (see FIG. 28A or 28B). The correction result image obtained by using the decreased coefficient k_{MIX} corresponds to the adjusted correction result image. Note that if the predetermined adjustment finishing operation is performed without performing the touch panel adjusting operation, the image 600[tₘ] or 600′[tₘ] functions as the adjusted correction result image.

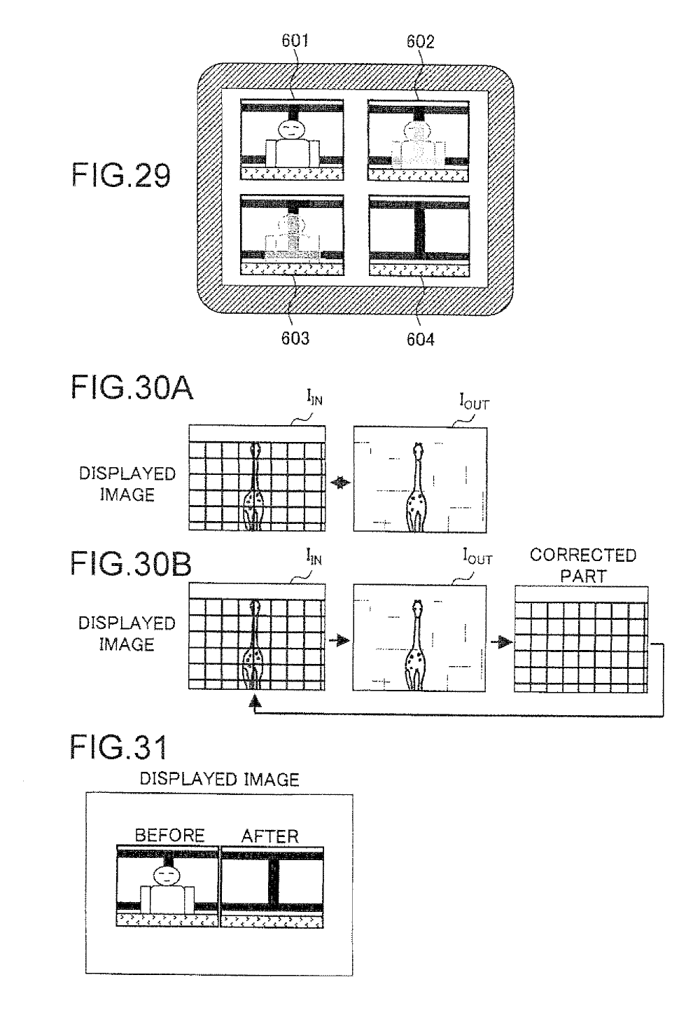

The second adjust method is described. When the second adjust method is adopted, the image correcting portion 30 temporarily stores the half-way correction results obtained in Step S85. Then, in Step S86, the image correcting portion 30 outputs the stored plurality of half-way correction results simultaneously to the display portion 16. In other words, as illustrated in FIG. 29, the plurality of half-way correction results are displayed simultaneously in a state arranged in the horizontal and vertical directions. For instance, four resulting mixed images 601 to 604 obtained by performing the process of Steps S12 to S20 of FIG. 12 in states where 0.25, 0.5, 0.75, and 1 are substituted into the coefficient k_{MIX} are arranged in the horizontal and vertical directions and are displayed simultaneously. In FIG. 29, the hatched region indicates a case of the display portion 16. In the state where the resulting mixed images 601 to 604 are simultaneously displayed, the user can select one of the resulting mixed images 601 to 604 as the adjusted correction result image by the touch panel operation or the button operation. If there are many resulting mixed images to be displayed, it is possible to display the resulting mixed images in a plurality of times.

The second adjust method can be expressed as follows. The image correcting portion 30 (the first correction processing portion 36 or the second correction processing portion 37 in FIG. 17) divides the correction of the image in the correction target region into a plurality of corrections so as to performs the corrections step by step (the value of the coefficient k_{MIX} is gradually increased while performing the corrections step by step). The plurality of correction result images obtained by performing the corrections step by step (the images 601 to 604 in the example of FIG. 29) are simultaneously output to the display portion 16 and are displayed. In a state where the display is performed, the adjusted correction result image is selected in accordance with a user's selection operation.

Note that in order to realize the first and the second adjust methods, it is necessary to keep an interactive relationship between the image pickup apparatus 1 and the user (for example, it is necessary to update the correction result image to be displayed in real time in accordance with a user's operation). Therefore, it is desirable to perform the correction process in a state where the input image I_{IN} is reduced (namely, in a state of a resolution lower than the maximum resolution) until content of the adjustment is fixed, and it is desirable to perform the correction process in a state where the input image I_{IN} is not reduced (namely, in a state of the maximum resolution) after the content of the adjustment is fixed.

After the adjustment in Step S86, the image pickup apparatus 1 performs confirmation display of the correction result image in Step S87.

Simply, for example, the image pickup apparatus 1 displays the output image I_{OUT} that is an image obtained by completely or partially eliminating the unneeded object from the input image I_{IN}.

Alternatively, for example, as illustrated in FIG. 30A, the input image I_{IN} and the output image I_{OUT} are automatically displayed alternately at a constant time interval or are displayed alternately in accordance with a user's operation.

Alternatively, for example, as illustrated in FIG. 30B, the input image I_{IN}, the output image I_{OUT}, and the corrected part (namely, the unneeded object or the unneeded region) are automatically switched and displayed at a constant time interval, or are switched and displayed in accordance with an user's operation.

Alternatively, for example, the input image I_{IN} and the output image I_{OUT} may be displayed simultaneously in parallel. In this case, it is preferred to display a part of the input image I_{IN} and a part of the output image I_{OUT} simultaneously in parallel so that the correction target region is enlarged and displayed. For instance, if the images 310 and 350 in FIGS. 4 and 7 are the input image I_{IN} and the output image I_{OUT}, respectively, it is preferred to enlarge the images in the correction target region before and after the correction (for example, the image 321 in FIG. 5A and the image 384 in FIG. 9) and to display them simultaneously in parallel as illustrated in FIG. 31. An enlargement ratio of the display may be an arbitrary value, and it is possible to adopt a structure in which the enlargement ratio can be changed in accordance with a user's operation. It is possible to accept a touch panel adjusting operation in a state where the images in the correction target region before and after the correction are displayed in parallel, so as to update the images in the correction target region after the correction in accordance with the touch panel adjusting operation. It is also possible to reflect a result of the update on the display content in real time.

After Step S87, if the user issues an instruction to add other unneeded region, the process goes back to Step S81 in which the process of Steps S81 to S87 is performed on the other unneeded region (Step S88). If there is no instruction to add other unneeded region, the output image I_{OUT} obtained finally at that time is recorded in the recording medium 15.

In addition, in the image processing for eliminating the unneeded region performed in Steps S84 and S85, the correction patch region for eliminating the unneeded region (such as the region 340 in FIG. 6B) is extracted and set. If the extracted and set correction patch region has a problem, the unneeded region may not be appropriately eliminated (the unneeded region may not be eliminated as the user wanted). If the user confirms that the unneeded region is not appropriately eliminated, the user can perform a predetermined retry instruction operation. While the half-way correction result is being displayed on the display portion 16 in Step S85, or at an arbitrary timing after the display in Step S85 is completed, the user can perform the retry instruction operation. The retry instruction operation is an operation for instructing to retry the image processing for eliminating the unneeded region (namely, retry to correct the image in the correction target region) and is realized by a predetermined button operation or touch panel operation.

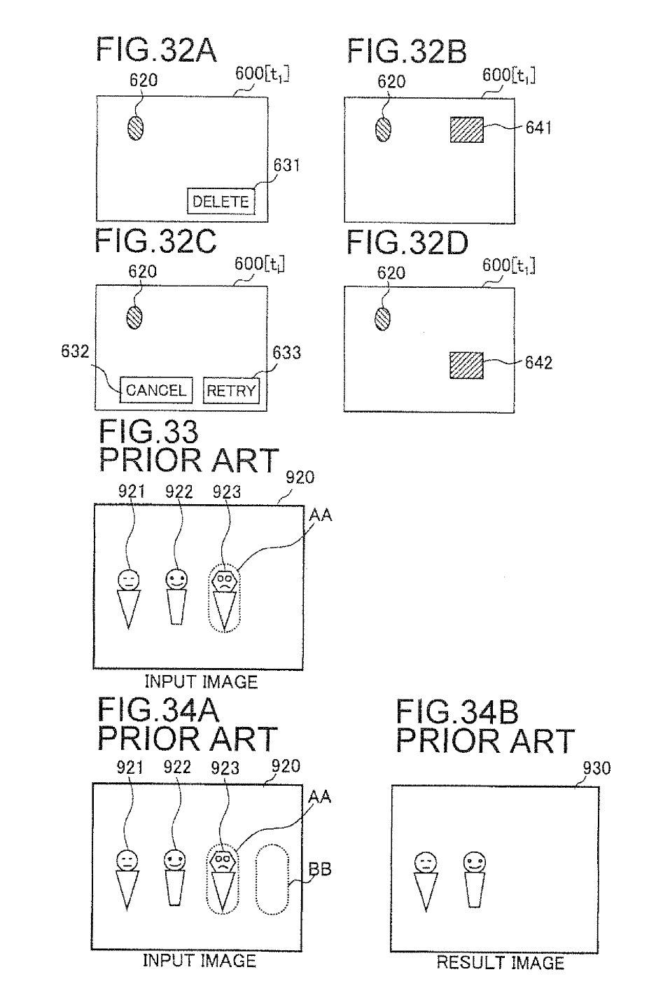

An action example and a display screen example when the retry instruction operation is performed are described with reference to FIGS. 28A, 32A and the like. For specific description, it is supposed that the image 600[t₁], 600[t₂], . . . , 600[tₘ₋₁], and 600[tₘ] are sequentially displayed on the display portion 16 in Step S85. The image 600[t₁] is also displayed in Step S84, and in this case, the image pickup apparatus 1 can display a delete icon 631 together with the image 600[t₁] as illustrated in FIG. 32A. A hatched region 620 indicates the unneeded region. Arbitrary icons including the delete icon 631 can be displayed in a superimposed manner on the image to be displayed, or can be displayed in parallel with the image to be displayed. The user can instruct to perform a process assigned to an icon on the display screen by touching the icon by a finger.

When the user touches the delete icon 631 by a finger, the image correcting portion 30 extracts and sets the correction patch region for eliminating an unneeded region (region for correction) 641 by the above-mentioned method (see FIG. 32B). The correction patch region 641 is extracted from the image 600[t₁] as the input image including the unneeded region via searching for the similar region as described above. However, as described above, the correction patch region 641 may be extracted from the input image different from the image 600[t₁]. After that, the image correcting portion 30 performs the image processing for eliminating the unneeded region using the image in the correction patch region 641, and hence the correction result images 600[t₂] to 600[tₘ] are sequentially displayed in Step S85 (see FIG. 28A).

At an arbitrary timing after the image processing for eliminating the unneeded region is started, the image pickup apparatus 1 can display a cancel icon 632 and a retry icon 633 on the display screen (see FIG. 32C). In the example of FIG. 32C, the icons 632 and 633 are displayed together with the correction result image 600[tᵢ]. When the cancel icon 632 is pressed by a finger, the image correcting portion 30 stops the image processing for eliminating the unneeded region that is being performed. The retry icon 633 can be displayed also after the image processing for eliminating the unneeded region is completed using the correction patch region 641. In other words, during or after execution of the image processing for eliminating the unneeded region using the correction patch region 641, the retry icon 633 can be displayed. If the user is not satisfied with the correction result image 600[tᵢ] displayed in Step S85, the user can press the retry icon 633 by a finger. Dissatisfaction with the correction result image is caused mainly by that the correction patch region is not appropriate.

The user's operation of pressing the retry icon 633 by a finger is a type of the retry instruction operation. When the retry instruction operation is performed, the image correcting portion 30 extracts and sets the correction patch region for eliminating the unneeded region again by the above-mentioned method. A hatched region 642 in FIG. 32D indicates the correction patch region that is newly extracted and set after the retry instruction operation. The new correction patch region 642 is different from the correction patch region 641. In other words, after the retry instruction operation, an image region different from the correction patch region 641 that is already extracted is extracted as the correction patch region 642. The correction patch region 642 is extracted from the image 600[t₁] as the input image including the unneeded region via searching for the similar region, as described above. However, as described above, the correction patch region 642 may be extracted from an input image different from the image 600[t₁]. After that, the image correcting portion 30 performs the image processing for eliminating the unneeded region again using the image in the correction patch region 642. The action after the image processing for eliminating the unneeded region is the same as that described above. Note that if the user is still not satisfied with the correction result using the correction patch region 642, the user can perform a second retry instruction operation, and in this case, a correction patch region 643 (not shown) different from the correction patch regions 641 and 642 is extracted, and the correction is performed by using an image in the correction patch region 643.

In addition, when the correction patch region 641 is extracted, it is preferred to clearly display the correction patch region 641 (for example, to perform blinking display or contour emphasizing display of the correction patch region 641) so that the user can confirm the position, size and the like of the correction patch region 641 on the input image. Similarly, when the correction patch region 642 is extracted, it is preferred to clearly display the correction patch region 642 (for example, to perform blinking display or contour emphasizing display of the correction patch region 642) so that the user can confirm the position, size and the like of the correction patch region 642 on the input image. The clear display of the correction patch region can be applied to an arbitrary correction patch region. In other words, in the embodiments including this embodiment, it is possible to perform or not perform the clear display of the correction patch region.

By making the process illustrated in FIGS. 32A to 32D be available, even if there is a problem in the correction patch region that is once set, it is possible to provide the user with a satisfied correction result image at the end.

### Fifth Embodiment

A fifth embodiment of the present invention is described.

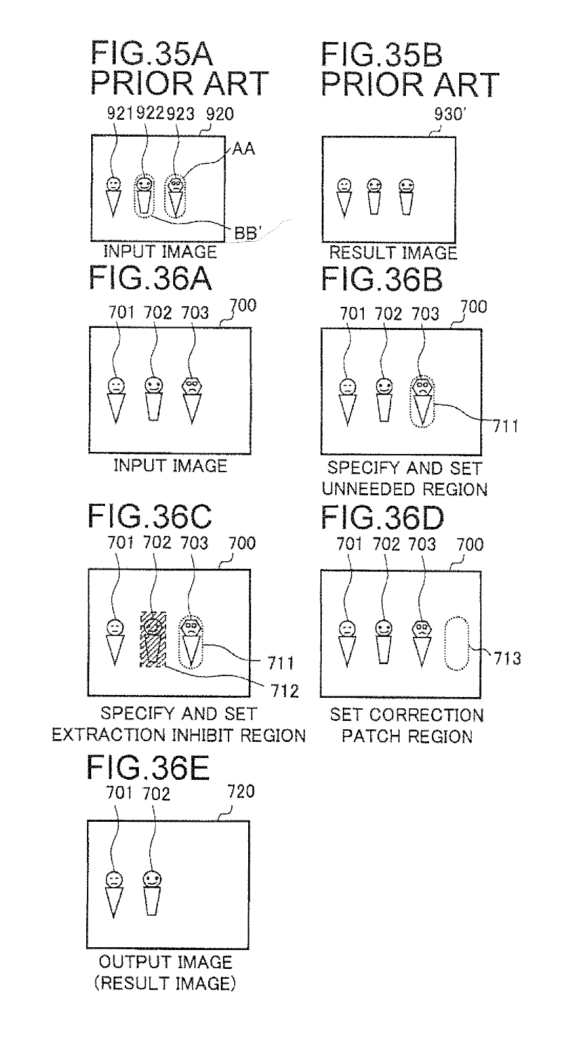

In the fifth embodiment, there is described a method in which generation of a result image against a user's intention such as the result image 930′ of FIG. 35B can be easily avoided.

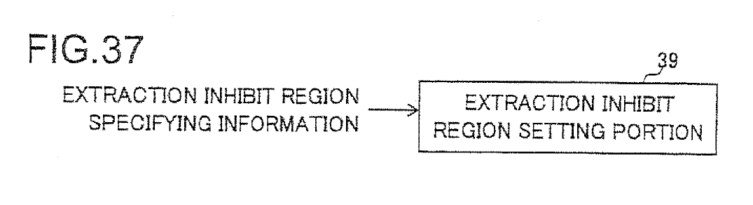

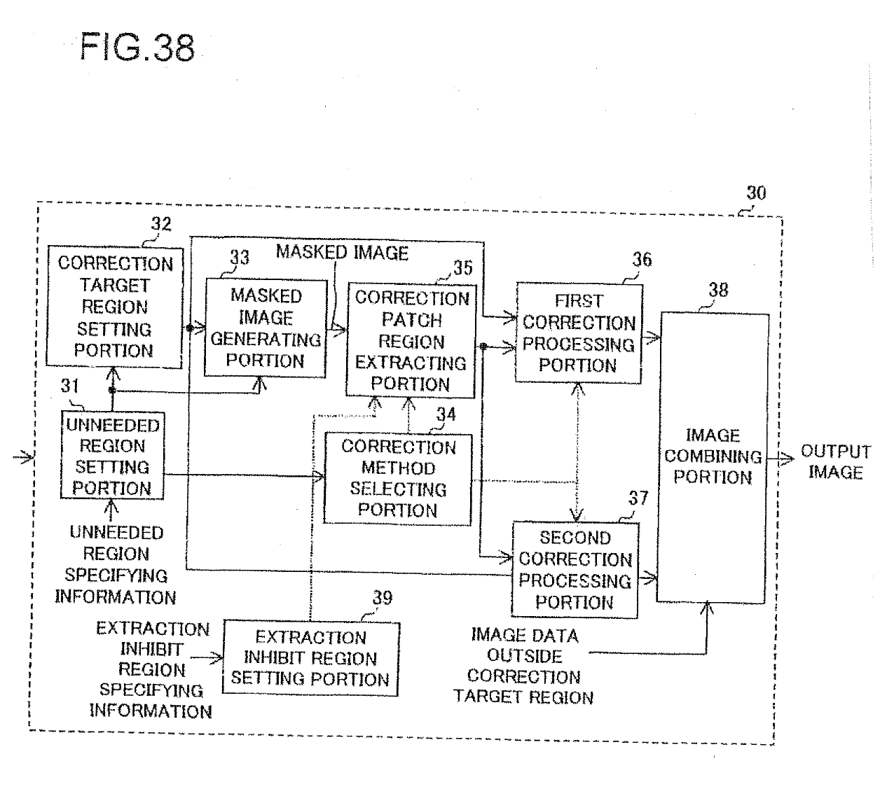

With reference to FIGS. 36A to 36E, the method according to the fifth embodiment is described. FIG. 37 illustrates an extraction inhibit region setting portion 39 that can be disposed in the image correcting portion 30 (see FIGS. 2 and 17). FIG. 38 illustrates an example of an internal structure of the image correcting portion 30 in a case where the extraction inhibit region setting portion 39 is added to the image correcting portion 30 of FIG. 17.

It is supposed that an image 700 illustrated in FIG. 36A is input as the input image I_{IN} to the image correcting portion 30. It is supposed that the input image 700 includes images of persons 701 to 703, and that the user regards the person 703 as the unneeded object. In this case, the user performs an operation for specifying the image region 711 surrounding the person 703 as the unneeded region by the touch panel operation or the button operation (see FIG. 36B). As this operation, the above-mentioned arbitrary unneeded region specifying operation can be used. When information indicating content of the unneeded region specifying operation is sent as the unneeded region specifying information to the unneeded region setting portion 31 (see FIG. 38), the unneeded region setting portion 31 sets the image region 711 to the unneeded region based on the unneeded region specifying information.

After the unneeded region specifying operation, the user can perform an extraction inhibit region specifying operation for specifying the extraction inhibit region by the touch panel operation or the button operation. The extraction inhibit region setting portion 39 sets the extraction inhibit region based on an extraction inhibit region specifying information indicating content of the extraction inhibit region specifying operation. The setting of the extraction inhibit region includes setting of a position, size, shape, and contour of the extraction inhibit region in the input image. Here, it is supposed that the user specified an image region surrounding the person 702 as an extraction inhibit region 712 by the extraction inhibit region specifying operation (see FIG. 36C). The method of specifying and setting the extraction inhibit region based on the extraction inhibit region specifying operation is the same as the method of specifying and setting the unneeded region based on the unneeded region specifying operation.

As described above, the unneeded region is eliminated by using the image data in the correction patch region, but the image data in the extraction inhibit region cannot be used as the image data in the correction patch region. In other words, the correction patch region is extracted from the image region except for the extraction inhibit region in the input image, and it is inhibited to extract an image region overlapping with the extraction inhibit region as the correction patch region. In the case of the example of FIG. 36C, the correction patch region is searched for and is extracted from the region (remaining region) obtained by removing the extraction inhibit region 712 from the entire image region of the input image 700. The method of searching for and extracting the correction patch region is the same as that described above in the first embodiment. As a result, the region inside a broken line 713 in FIG. 36D is extracted as the correction patch region. The correction patch region 713 and the extraction inhibit region 712 do not overlap with each other. Note that as described above in the first embodiment, it is possible to extract the correction patch region from an input image 700′ (not shown) different from the input image 700, and in this case, it is also possible to set the extraction inhibit region in the input image 700′.

After the correction patch region is extracted and set, the input image 700 is corrected by the method described above in the first embodiment, and hence an output image 720 as the result image can be obtained (see FIG. 36E). In the example of FIGS. 36D and 36E, a background region different from the extraction inhibit region 712 is set as the correction patch region 713, and hence the unneeded person 703 in the output image 720 can be appropriately eliminated. Note that the number of the extraction inhibit region is one in the above-mentioned example, but the number of the extraction inhibit region may be two or larger (namely, the user can also specify a plurality of extraction inhibit regions).

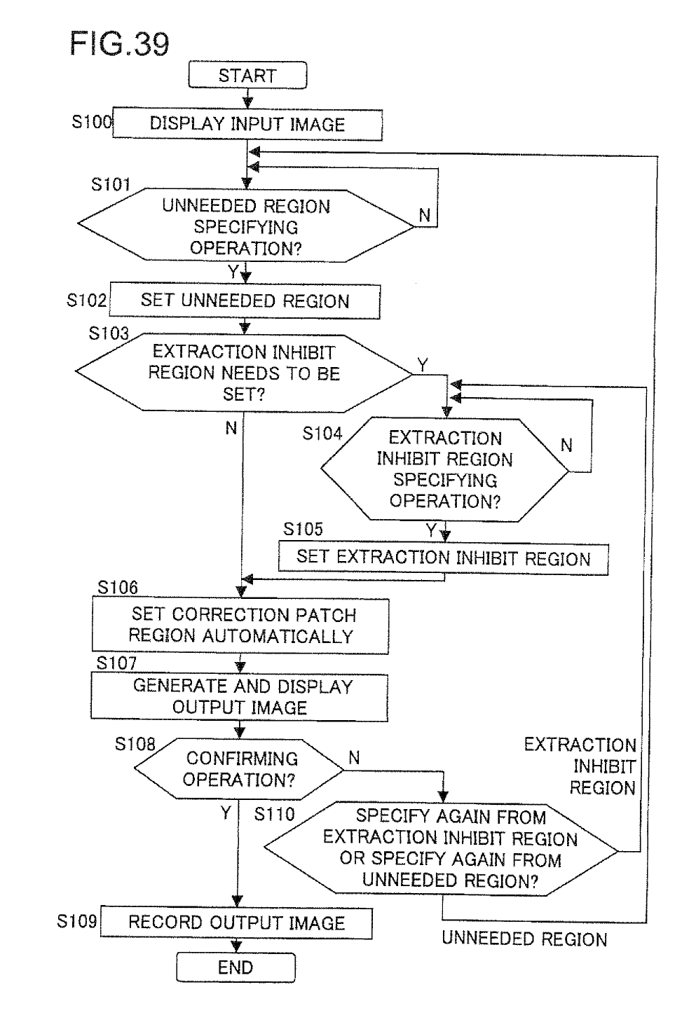

With reference to FIG. 39, an action procedure of the image pickup apparatus 1 in the unneeded object elimination mode is described. For specific description, it is supposed that the output image 720 is obtained from the input image 700 via setting of the unneeded region 711 and the extraction inhibit region 712, and each process in FIG. 39 is described. In the description with reference to FIG. 39, FIG. 12 may be appropriately referred to, and when FIG. 12 is referred to, the correction target region including the unneeded region 711 may be referred to as a correction target region A, while the set correction patch region may be referred to as a correction patch region B. Each process illustrated in FIG. 39 is performed in the unneeded object elimination mode. For instance, the unneeded object elimination mode starts if a predetermined touch panel operation or button operation is performed when the input image 700 is displayed on the display portion 16 just after the input image 700 is taken, or if a predetermined menu is selected in the reproduction mode.

When the unneeded object elimination mode starts, the image pickup apparatus 1 displays the input image 700 (Step S100) and waits for an input of the unneeded region specifying operation by the user in Step S101. When the unneeded region specifying operation is input, the unneeded region setting portion 31 sets the unneeded region 711 in accordance with the unneeded region specifying operation in Step S102. The user can directly specify a position, size, shape, contour and the like of the unneeded region 711 using the touch panel operation (the same is true for the extraction inhibit region 712). Alternatively, it is possible to let the user select the unneeded region 711 among a plurality of image regions prepared in advance using the button operation or the like (the same is true for the extraction inhibit region 712).

After the unneeded region 711 is set, the image pickup apparatus 1 inquires the user in Step S103 whether or not the extraction inhibit region needs to be set. Then, only if it is replied that the extraction inhibit region needs to be set, the process goes from Step S103 to Step S104, the process of Steps S104 and S105 is performed, and then the process goes to Step S106. On the other hand, if it is replied that the extraction inhibit region does not need to be set, the process goes from Step S103 directly to Step S106.

In Step S104, the image pickup apparatus 1 waits for input of the extraction inhibit region specifying operation by the user. When the extraction inhibit region specifying operation is input, the extraction inhibit region setting portion 39 sets the extraction inhibit region 712 in accordance with the extraction inhibit region specifying operation in Step S105. When the extraction inhibit region 712 is set, the process goes from Step S105 to Step S106.

In Step S106 after Step S103 or S105, the image correcting portion 30 (the correction patch region extracting portion 35) automatically extracts and sets the correction patch region without a user's operation. As a method of extracting and setting the correction patch region, the method described above in the first embodiment can be used. In other words, for example, after the correction target region 320 of FIG. 4 including the unneeded region is set, by the same method as extracting the correction patch region 340 from the input image 310 as illustrated in FIG. 6B, the correction target region including the unneeded region 711 is set in the input image 700, and the correction patch region corresponding to the correction target region in the input image 700 is extracted from the input image 700. Alternatively, for example, the correction patch region can be set in the input image 700 (or 700′) by the process of Steps S12 to S18 in FIG. 12. In any case, if the extraction inhibit region 712 is set, the correction patch region is extracted from the image region except for the extraction inhibit region 712 in the input image 700 (or 700′). As a result, for example, the correction patch region 713 of FIG. 36D is extracted and set.

Note that if a plurality of similar regions are found when the process of Steps S12 to S18 of FIG. 12 is used (Step S15), the user selects the correction patch region from the plurality of similar regions in the first embodiment. In contrast, in this embodiment, in order to reduce a user's operation load, it is preferred to automatically set the correction patch region without allotting the selection operation to the user in Step S106 (however, it is possible to allot the above-mentioned selection operation to the user). In addition, when the process of Steps S12 to S18 of FIG. 12 is applied to Step S106 of FIG. 39, if the shape of the unneeded region is decided to be a thin line shape (Y in Step S14), it is possible to set the correction patch region by the process of Step S19 of FIG. 12. In this case, a correction patch region different from the correction patch region 713 is set in Step S106.

After the correction patch region is set in Step S106, the image correcting portion 30 generates the output image 720 based on the input image 700 in Step S107. As a method of generating the output image from the input image after the unneeded region and the correction patch region are set, it is possible to use the method described above in the first embodiment. For instance, the process of Step S20 of FIG. 12 can be used. More specifically, for example, the image data of the correction target region A including the unneeded region 711 is mixed with the image data of the correction patch region B (for example, the correction patch region 713 or a correction patch region different from the correction patch region 713), so that the resulting mixed image is generated. The generated resulting mixed image is fit in the correction target region A of the input image 700 so that the output image 720 is generated. The value of the coefficient k_{MIX} in this mixing may be one. If k_{MIX}=1 holds, the image data in the correction target region A is replaced with the image data in the correction patch region B in the input image 700.

In addition, it is also possible to extract a plurality of correction patch regions from the image region except for the extraction inhibit region 712 in the input image 700 (or 700′). If the plurality of correction patch regions are extracted, it is possible to generate the image data in the correction target region A of the output image 720 using the image data of the plurality of correction patch regions.

In Step S107, the generated output image 720 is also displayed. While performing this display, the image pickup apparatus 1 inquires the user in Step S108 whether or not content of the correction is confirmed. In response to this inquiry, the user can perform a predetermined confirming operation using the touch panel operation or the button operation.

When the user does not perform the confirming operation, the user can perform an operation for specifying again from the extraction inhibit region or an operation for specifying again from the unneeded region using the touch panel operation or the button operation (Step S110).

If the user performs the former operation, the process goes back from Step S108 to Step S104 via Step S110, and the process of Steps S104 to S108 is performed again. In the process, the extraction inhibit region is specified again and is reset, and the output image is generated again.

If the user performs the latter operation, the process goes back from Step S108 to Step S101 via Step S110, and the process of Steps S101 to S108 is performed again. In the process, the unneeded region and the extraction inhibit region are specified again and are reset, and the output image is generated again.

If the user performs the confirming operation in Step S108, the image data of the latest output image generated in Step S107 is recorded in the recording medium 15 (Step S109), and the action of FIG. 39 is finished. Note that it is possible to perform the adjusting process described above in the first embodiment (for example, see Step S26 of FIG. 12) on the output image generated in Step S107, so as to record the output image after the adjusting process in the recording medium 15.

As this embodiment, with the set function of the extraction inhibit region, it is possible to avoid inappropriate extraction of the correction patch region by small operation load (to avoid extraction of the region inhibited by the user as the correction patch region). As a result, it is possible to avoid generation of an undesired output image. In other words, it is possible to generate the output image according to user's intention by small operation load.

It is also possible to adopt a method of providing the user with a plurality of candidate regions that can be used as the correction patch region so that the user selects the correction patch region from the plurality of candidate regions. However, if there are many candidate regions, or if one unneeded region is corrected by using a plurality of correction patch regions, user's operation load becomes heavy to some extent. By automatically selecting and setting the correction patch region in the image pickup apparatus 1, even if there are many candidate regions, user's operation load becomes light.

Note that as described above, the technique described in the fifth embodiment may be combined with the technique described in the first embodiment. Therefore, it is possible to describe as follows.

In the first embodiment, it is possible to add the extraction inhibit region setting portion 39 to the image correcting portion 30, and to set the extraction inhibit region in the input image in accordance with the extraction inhibit region specifying operation. Further, in the first embodiment, it is preferred to extract the correction patch region from the image region except for the extraction inhibit region in the input image (namely, it is preferred to inhibit extraction of an image region overlapping with the extraction inhibit region as the correction patch region).

In addition, it is also possible to perform the following variation action in the image pickup apparatus 1. In the description of the variation action, it is supposed that the unneeded region 711 is set with respect to the input image 700, and that the correction target region A including the unneeded region 711 is set in the input image 700. In addition, the masked image based on the correction target region A is denoted by symbol A_{MSK}. In addition, in the variation action, the method of Step S15 in FIG. 12 can be used for searching the similar region.

The first variation action is described. To search for the region similar to the masked image A_{MSK} as the correction patch region B from the input image 700 or 700′ so as to correct the image in the correction target region A using the correction patch region B is referred to as unit correction. The unit correction is realized by mixing the image data of the correction patch region B with the image data of the correction target region A or by replacing the image data of the correction target region A with the image data of the correction patch region B. In the first variation action, the unit correction is repeatedly performed a plurality of times. The correction target region A in a state where the unit correction is never performed is denoted by symbol A[0], the correction target region A obtained by the i-th unit correction is denoted by symbol A[i], the masked image based on the correction target region A[i] is denoted by symbol A_{MSK}[i], and the correction patch region B found with respect to the masked image A_{MSK}[i] is denoted by symbol B[i].

Then, in the first unit correction, the region similar to the masked image A_{MSK}[0] is searched for as the correction patch region B[0] from the input image 700 or 700′, and the image in the correction target region A[0] is corrected by using the correction patch region B[0] so that the correction target region A[1] is obtained. In the second unit correction, the region similar to the masked image A_{MSK}[1] based on the correction target region A[1] is searched for as the correction patch region B[1] from the input image 700 or 700′, and the image in the correction target region A[1] is corrected by using the correction patch region B[1] so that the correction target region A[2] is obtained. The same is true for the third and following unit corrections.

The unit correction can be performed repeatedly until the image in the correction target region A is hardly changed by the new unit correction. For instance, a difference between each pixel signal in the correction target region A[i−1] and each pixel signal in the correction target region A[i] is determined. If it is decided that the difference is sufficiently small, the repeated execution of the unit correction is finished. If it is not decided that the difference is sufficiently small, the (i+1) the unit correction is further performed so as to obtain the correction target region A[i+1]. It is possible to set the number of repeating times of the unit correction in advance. If the repeated execution of the unit correction is finished when the correction target region A[i] is obtained, the image data of the correction target region A[i] is fit in the correction target region A of the input image 700 so that the output image 720 is obtained.

A second variation action is described. If the correction target region A is relatively large, one correction patch region B to be fit in the correction target region A may not be found. In this case, the second variation action can be used usefully.

In the second variation action, the correction target region A is divided into a plurality of image regions. The image regions obtained by the division are referred to as divided regions. Then, for each of the divided regions, the correction patch region is searched for so as to perform the unit correction. For specific description, it is supposed that the correction target region A is divided into four divided regions A₁ to A₄. When the divided regions A₁ to A₄ are set, the masked image A_{MSK} is also divided into four divided masked images A_{MSK1} to A_{MSK4}. The divided masked image A_{MSKj} is a masked image corresponding to the divided regions Aⱼ (j denotes 1, 2, 3, or 4).

In one unit correction in the second variation action, a region similar to the divided masked image A_{MSKi} is searched for as a correction patch region Bⱼ from the input image 700 or 700′, and, for each of the divided regions, the process of correcting the image in the divided region Aⱼ is performed by using the correction patch region Bⱼ. It is possible to perform the unit correction only once, or it is possible to repeat the unit correction a plurality of times as the method described above in the first variation action. It is supposed that the repeated execution of the unit correction is finished when the i-th unit correction is performed. Then, image data of the divided regions A₁ [i] to A₄[i] are fit in the divided regions A₁ to A₄ of the input image 700, respectively, and hence the output image 720 is obtained. The divided region Aⱼ[i] is an image region obtained by performing the unit correction i times on the divided region Aⱼ on which the unit correction is never performed.

[Variations]

The specific values shown in the above description are merely examples, and the values can be changed variously as a matter of course.

In the above-mentioned embodiment, it is supposed that the image processing portion 14 and the image correcting portion 30 are disposed in the image pickup apparatus 1 (see FIG. 1), but the image processing portion 14 or the image correcting portion 30 may be mounted in an electronic apparatus (not shown) different from the image pickup apparatus 1. The electronic apparatus may be a display device such as a television receiver, a personal computer, or a mobile phone. The image pickup apparatus is also one type of the electronic apparatus. It is preferred that the electronic apparatus be equipped with the recording medium 15, the display portion 16, and the operation portion 17 in addition to the image processing portion 14 or the image correcting portion 30.

The image pickup apparatus 1 of FIG. 1 or the above-mentioned electronic apparatus may be constituted of hardware or a combination of hardware and software. When the image pickup apparatus 1 or the above-mentioned electronic apparatus is constituted using software, a block diagram of a portion realized by software indicates a functional block diagram of the portion. It is possible to describe the function realized by using software as a program, and to execute the program on a program executing device (for example, a computer) so as to realize the function.

What is claimed is:

1. An image processing device comprising a correcting portion which corrects an image in a target region included in a first input image, wherein
the correcting portion includes a correction processing portion which corrects the image in the target region using an image in a region for correction included in a second input image that is the same as or different from the first input image, and a correction region extracting portion which extracts the region for correction from the second input image based on image data of the target region.

2. The image processing device according to claim 1, wherein
the correcting portion further includes an extraction inhibit region setting portion which sets an extraction inhibit region in the second input image in accordance with a given operation, and
the correction region extracting portion extracts the region for correction from an image region other than the extraction inhibit region in the second input image.

3. The image processing device according to claim 1, wherein
the correcting portion further includes a target region setting portion which specifies an unneeded region included in the first input image so as to set an image region including the unneeded region as the target region, and
the correction region extracting portion compares image data of a remaining region other than the unneeded region in the target region with image data of the second input image so as to detect and extract the region for correction from the second input image.

4. The image processing device according to claim 3, wherein the correction region extracting portion searches for an image region having image feature similar to image feature of the remaining region from the second input image, so as to extract an image region including the found image region as the region for correction from the second input image.

5. The image processing device according to claim 1, wherein the region for correction is clearly displayed by using a display portion connected to the image processing device.

6. The image processing device according to claim 1, wherein
when it is instructed to redo the correction during or after the correction by the correction processing portion,
the correction region extracting portion extracts an image region different from the already extracted region for correction as a new region for correction from the second input image, and
the correction processing portion corrects the image in the target region using an image in the newly extracted region for correction.

7. The image processing device according to claim 3, wherein the correcting portion further includes, in addition to the correction processing portion as a first correction processing portion, a second correction processing portion which corrects the image in the target region using an dilation process for reducing the unneeded region, and corrects the image in the target region by selectively using the first and the second correction processing portions in accordance with the shape of the unneeded region.

8. The image processing device according to claim 3, wherein the correcting portion further includes an unneeded region setting portion which receives an input of a specified position and sets the unneeded region based on the specified position and image data of the first input image so that the specified position is included in the unneeded region.

9. The image processing device according to claim 1, wherein the correction processing portion divides the correction of the image in the target region into a plurality of corrections so as to performs the corrections step by step, and a plurality of correction result images obtained by performing the corrections step by step are sequentially output to a display portion.

10. The image processing device according to claim 1, wherein the correction processing portion divides the correction of the image in the target region into a plurality of corrections so as to performs the corrections step by step, and a plurality of correction result images obtained by performing the corrections step by step are simultaneously output to a display portion.

11. An electronic apparatus comprising the image processing device according to claim 1.

12. An electronic apparatus comprising:
an image processing device including a correcting portion which corrects an image in a target region included in the first input image;
a display portion which displays a whole or a part of the first input image; and
an operation portion which accepts an unneeded region specifying operation for specifying an unneeded region included in the first input image and accepts a correction instruction operation for instructing to correct an image in the unneeded region, wherein
the correcting portion includes a target region setting portion which sets an image region including the unneeded region as the target region, a correction processing portion which corrects the image in the target region using an image in a region for correction included in a second input image that is the same as or different from the first input image, and a correction region extracting portion which extracts the region for correction from the second input image based on image data of the target region,
the correcting portion corrects the image in the target region in accordance with the correction instruction operation, and
the display portion displays the image in the target region after the correction when the correction is performed.

13. The electronic apparatus according to claim 12, wherein
the correcting portion further includes an extraction inhibit region setting portion which sets an extraction inhibit region in the second input image in accordance with an extraction inhibit region specifying operation performed with the operation portion,
the correcting portion corrects the image in the target region in accordance with the correction instruction operation,
the display portion displays the image in the target region after the correction when the correction is performed, and
the correction region extracting portion extracts the region for correction from an image region other than the extraction inhibit region in the second input image.
